(19) United States
(12) Patent Application Publication
(10) Pub. No.: US 2026/0257655 A1
(43) Pub. Date: Sep. 3, 2026

(54) LATERAL LOADING BRAKE FLUID TRANSIT PREVENTION DEVICE

(71) Applicant: ALCON COMPONENTS LIMITED, Staffordshire (GB)

(72) Inventors: David CLEGG, Staffordshire (GB); Garry WISEMAN, Staffordshire (GB); Jamie HUMBLE, Staffordshire (GB)

(21) Appl. No.: 19/488,448

(22) PCT Filed: May 31, 2024
(86) PCT No.: PCT/GB2024/051428

§ 371 Date: Nov. 26, 2025

(30) Foreign Application Priority Data
May 31, 2023 (GB) 2308098.9

(51) Int. Cl. B60T 13/68; B60T 8/171; B60T 8/172; B60T 13/14

(52) U.S. Cl. CPC B60T 13/686; B60T 8/171; B60T 8/172; B60T 13/14; B60T 2220/04; B60T 2230/00; B60T 2250/04

(57) ABSTRACT

Fluid transit prevention devices and control systems for controlling a brake system of a vehicle are disclosed. The brake system may include a brake fluid reservoir fluidically connected to a hydraulically actuated brake via an electromechanical valve. The control system may include one or more processors collectively configured to determine or receive an acceleration signal comprising information indicative of a vehicle lateral acceleration and determine whether the vehicle lateral acceleration is at or exceeds a predetermined threshold value. A valve signal for actuating the electromechanical valve may be output in response to whether the vehicle lateral acceleration exceeds the predetermined threshold value.

### CROSS REFERENCE TO RELATED APPLICATIONS

This application is a U.S. nationalization under 35 U.S.C. § 371 of International Application No. PCT/GB 2024/051428, filed May 31, 2024, which claims priority to United Kingdom Patent Application No. GB 2308098.9, filed May 31, 2023. The disclosures set forth in the referenced applications are incorporated herein by reference in their entireties for all purposes.

### FIELD

The present invention relates to a fluid transit prevention device for a fluid brake system and a control system. It also relates to a vehicle and/or a fluid brake system and/or brake system having such a device or control system.

### BACKGROUND

Vehicles with fluid brake systems, and especially for such vehicles that have high cornering velocities (such as those participating in high-performance motorsport events), experience an effect known as “knockback”. Standard fluid brake systems such as these provide braking force by contact between a brake disc and brake pads, the brake pads being actuated by pistons within piston cylinders housed by a brake caliper body. A reservoir provides a source of fluid for said actuation and a master cylinder provides said to fluid to each piston cylinder.

During a cornering event, the vehicle lateral loading from the lateral acceleration of cornering, combined with compliance in suspension components (such as the upright, bearing and hub), causes relative displacement between the brake disc and caliper body of the vehicle's fluid brake systems. This relative displacement causes contact between the brake pads and the brake disc, resulting in the brake pistons being pushed by the pads onto the piston cylinders. This in turn displaces fluid in the system from the brake caliper into the fluid reservoir.

After the cornering event, the brake disc returns to its original position relative to the caliper body and brake pads, however the displaced pistons and fluid do not return. As such, the next brake application must manage the fluid displacement required to bring the piston back to its original position, in addition to the usual fluid displacement.

This knockback causes inconsistent brake pedal travel for the user. Reducing this effect would allow for greater braking confidence (and thus shorter stopping distances) and a more reliable braking event.

Knockback cannot be mitigated by locking the fluid circuit to prevent movement of the fluid. This is because locking the high-pressure side of the circuit causes the further issue of preventing fluid from travelling to the brake caliper from the master cylinder. This restricts the brake, increasing the chance of a crash. An ABS unit can provide an alternative pre-apply, pre-fill solution, however an ABS system is an active control system, which is not permitted in many motorsport applications.

Another solution is to use a knockback valve that prevents rapid transfer of fluid up to a certain threshold via a narrow orifice within the valve. This is useful for such events such as a kerb or rumble strip strike, i.e., an event that shock loads the fluid in the brake system. However, this is not suitable for use to prevent knockback during a long corner at speed, as even a narrow orifice will allow fluid transmission as described above.

The present invention seeks to overcome or at least mitigate these disadvantages associated with knockback and/or high velocity cornering events. The present invention also seeks to provide devices and control systems that are reliable, easy to manufacture and cost effective.

### SUMMARY

Aspects and embodiments of the invention provide a fluid transit prevention device, a fluid brake system, a vehicle, a method of operating a fluid transit prevention device, a control system, a brake system, a second vehicle, a method of controlling a brake system, a computer-readable storage medium, a second control system, a second brake system, a third vehicle, a second method of controlling a brake system, and a second computer-readable storage medium.

A first aspect of the invention provides a fluid transit prevention device for a hydraulically actuated brake comprising a body defining a fluid channel having an inlet and an outlet spaced apart from one another; a first inertia mass; a second inertia mass; a fluid channel closure arranged between the inlet and outlet, which is actuable between an open condition in which fluid can flow in the fluid channel between the inlet and outlet and vice versa and a closed condition in which fluid is prevented from flowing in the fluid channel between the inlet and outlet and vice versa; a first biasing means arranged to act on the first inertia mass in a first direction away from the fluid channel closure; and a second biasing means arranged to act on the second inertia mass in a second direction opposite from the first direction and away from the fluid channel closure; wherein each inertia mass is arranged, under appropriate acceleration, to actuate the fluid channel closure from the open condition to the closed condition and wherein the fluid channel closure is configured to return to the open condition when not acted upon by either of the first or second inertia masses.

In this way, fluid can be prevented from flowing in both directions depending on the accelerations and therefore forces applied to the device. Acceleration in the first direction causes the first inertia mass to act against the fluid channel closure, actuating the fluid channel closure from the open position to the closed position. When the acceleration ceases, there is no longer a force causing the inertia mass to act on the fluid channel closure and the fluid channel closure is configured to move back to the open position. The same process happens for acceleration in the second direction with the respective components. This results in passive control of the fluid flow, as fluid travel is blocked under such accelerations. As such, a passive system that provides complete fluid transmit prevention is provided.

The term “under appropriate acceleration” is taken, in the context of the present application, to mean a transitory lateral acceleration. A transitory lateral acceleration is a lateral acceleration which acts upon the fluid transit prevention device in a lateral direction. The lateral direction may be a lateral direction relative to the normal position of the fluid transit prevention device in use. In other words, when in use the fluid transit prevention device is located in or on a vehicle, for example in a car, the lateral direction will be relative to the fluid transit prevention device when the vehicle is supported on a surface in an operational state (i.e. the vehicle is able to traverse along said surface under its own power being provided by an internal combustion engine or the like) and the lateral direction will be transverse to the fore-aft direction of the vehicle.

Preferably, where under appropriate acceleration is a lateral acceleration, more preferably where the lateral acceleration is a lateral acceleration event, even more preferably where the lateral acceleration is a transitory lateral acceleration, more preferably still where the transitory lateral acceleration is a transitory lateral acceleration event.

Transitory meaning non-permanent or acting for a period of time. As will be apparent a transitory acceleration will encompass both a constant acceleration applied for a period of time and an acceleration which changes across a period of time (e.g. oscillating, increasing, decreasing, sawtooth shaped, square shaped, sine wave shaped, etc).

Should such a vehicle be tipped on its side such that the wheels of said vehicle were no longer engaging the surface, e.g. the vehicle is on its side or upside down, this would not be a transitory lateral acceleration within the meaning of this application. In such a scenario, the acceleration due to gravity would be acting relative to the fluid transit prevention device located in the vehicle but would not be transitory. The acceleration will act in this scenario until the vehicle is returned to its ‘normal’ operational position. That being, for a four-wheeled car, all four wheels being engaged to the surface on which the car is supported.

In use the fluid transit prevention device is located between the hydraulically actuated brake and a brake fluid reservoir such that closing the device interrupts fluid transmission between the brake fluid reservoir and the hydraulically actuated brake when the device is in the closed position. Advantageously, this reduces the likelihood of knockback during a lateral acceleration event.

The location of the fluid transit prevention device in use differs from that of an anti-lock braking device or automated braking system (ABS) or brake assist. These type of devices or control systems work, for example, by actuating a master cylinder connected to a hydraulically actuated brake in order to rapidly apply and remove braking pressure to a brake disc to regain traction control in the case of a skid or prevent wheel lock up. These systems do not operate in the same way as the present invention as the skilled reader will understand.

The fluid channel closure may comprise a first reciprocating means and a second reciprocating means. The first and second reciprocating means may be first and second valves respectively. Valves enable a finely controllable rate of fluid flow and are widely available, increasing precision of the device whilst reducing cost of manufacture.

At least one of the inertia masses may be formed as part of the fluid channel closure. At least one of the biasing means may comprise an incline plane arranged to encourage one of the inertia masses away from the respective reciprocating means. At least one of the biasing means may be a spring. At least one of the biasing means may be an electromagnet. In this way, a controllable and linear force acting upon the fluid channel closure is achieved, to ensure an even and predictable action of the device.

The fluid transit prevention device may further comprise a first chamber having an inlet and the first valve, the first valve having a first valve member and a first biasing member, said first biasing member arranged to move said first valve member into the first chamber and thus from the closed position to the open position; and a second chamber having an outlet and the second valve, the second valve having a second valve member and a second biasing member, said second biasing member arranged to move said second valve member into the second chamber and thus from the closed position to the open position; wherein the first inertia mass is arranged within the first chamber and arranged to move within said chamber along a first axis upon acceleration of the device in a first direction, said movement causing the first inertia mass to act on the first valve member against the first biasing member, moving the first valve member from the open position to the closed position; and wherein the second inertia mass is arranged within the second chamber and arranged to move within said chamber along a second axis upon acceleration of the device in a second direction, said movement causing the second inertia mass to act on the second valve member against the second biasing member, moving the second valve member from the open position to the closed position; wherein the first and second valves are fluidly connected and the first and second chambers are relatively inclined such that the first and second axes are non-parallel.

In this way, fluid can be prevented from flowing in both directions depending on the accelerations and therefore forces applied to the device. Acceleration in the first direction causes the first inertia mass to move within the first chamber towards the first valve member. The inertia mass acts against the first biasing member, moving the valve member from the open position to the closed position. When the acceleration ceases, there is no longer a force causing the inertia mass to act on the valve member and so the biasing member moves the valve member back to the open position. The same process happens for acceleration in the second direction with the respective components. This results in passive control of the fluid flow, as fluid travel is blocked under such accelerations. As such, a passive system that provides complete fluid transmit prevention is provided.

The fluid transit prevention device may further comprise a horizontal axis and at least one of the first and second axes may be inclined relative to said horizontal axis. The first and second axes may be inclined relative to the horizontal axis. Inclining the axes relative to the horizontal allows for gravity to be an additional force acting against the movement of the inertia masses. This allows for more accurate calibration of the device and ensures that the inertia masses will always return to a position away from the respective valve members when the device is under no/minimal acceleration.

The first and second chambers may be formed within a single body. By forming the chambers this way, manufacturing and assembly of the device is improved. Rather than having to fit a complicated set of components, the device can instead be easily fitted inline in a fluid brake system.

At least one of the first and second inertia masses may be spherical. The first and second inertia masses may be spherical. The first and second inertia masses may be steel balls, preferably stainless steel. In this way, the simplicity of manufacturing the device is increased, whilst reducing the chance of a blockage of the system due to the spherical shape of the inertia masses. Furthermore, steel (and especially stainless steel) does not react with commonly used brake fluid, resulting in a lower chance of corruption of said fluid, which could alter the braking properties.

The first and second chambers may be substantially cylindrical. The first and second inertia masses may have diameters proximate to that of the diameter of the respective first or second chamber, such that minimal fluid can pass between the inertia mass and walls of the respective chamber. Thus, fluid loss around the inertia masses is minimised.

At least one of the first and second biasing members may be a spring. The first and second biasing members may be springs. Each spring may be a conical spring having a narrow end and a wide end. Each spring may be arranged such that the narrow end acts on the respective chamber and the wide end acts on the respective valve member. Springs such as these can be finely tuned to provide the optimum resistive force against the movement of the inertia masses, in order to calibrate the action of the device.

The first and second valves may further comprise a first and second pin respectively, each attached to the first and second chamber respectively, and the first and second valve members may have first and second bores respectively therethrough, wherein the first and second pins may be arranged to pass through the first and second bores respectively to secure the first and second valve members to the first and second chamber respectively, whilst still allowing movement between the respective valve member and chamber. In this way, the valve members can be securely mounted to the chambers whilst still allowing the required movement. This method of securing the valve members also minimises the brake fluid that could escape through the joint.

The first and second valve members have a shaft portion and a head portion. Each shaft portion may have at least one hole therethrough to allow the passage of fluid. The holes may be arranged such that they are blocked by the respective chamber when the valve member is in the closed position. The first and second bores may be shaped to receive the respective inertia mass. Thus, the inertia masses provide an even spread of force across the head portion of the valve member.

A second aspect of the invention provides a fluid brake system comprising a brake caliper assembly having at least one piston with a master cylinder; the fluid transit prevention device described above; and a fluid reservoir; wherein the fluid reservoir is fluidly connected to the inlet of the fluid transit prevention device and the master cylinder is fluidly connected to the outlet of the fluid transit prevention device. In this way, a passive system that provides complete fluid transit prevention between the brake caliper and the fluid reservoir is provided.

The master cylinder may be fluidly connected to the outlet of the fluid transit prevention device via a collapsible hose. An internal cross-sectional area of the collapsible hose may be arranged to reduce when the fluid channel closure of the fluid transit prevention device is in the closed condition. The collapsible hose allows for volume compensation from the draw of the master cylinder as it moves slightly under use.

A third aspect of the invention provides a fluid brake system comprising a brake caliper assembly having at least one piston with a master cylinder; a valve having an inlet and an outlet; and a fluid reservoir; wherein the fluid reservoir is fluidly connected to the inlet of the valve and the master cylinder is fluidly connected to the outlet of the valve, and the valve is arranged to move between a closed position and an open position as a reaction to lateral acceleration of the fluid brake system. In this way, a passive system that provides complete fluid transit prevention between the brake caliper and the fluid reservoir is provided. The valve may be the fluid transit prevention device described above.

The master cylinder may be fluidly connected to the outlet of valve via a collapsible hose. An internal cross-sectional area of the collapsible hose may be arranged to reduce when the valve is in the closed condition. The collapsible hose allows for volume compensation from the draw of the master cylinder as it moves slightly under use.

An additional aspect of the invention describes a vehicle, the vehicle comprising any embodiment of the first, second or third aspects. Preferably, the vehicle may be any wheeled vehicle, such as a car, motorcycle, sport car, rally car, supercar, hypercar, coupé, Sports Utility Vehicle (SUV), an open-wheel single-seater formula racing car. A fourth aspect of the invention provides a method of operating a fluid transit prevention device for a hydraulically actuated brake, the fluid transit prevention device comprising a body defining a fluid channel having an inlet and an outlet spaced apart from one another; a first inertia mass; a second inertia mass; a fluid channel closure arranged between the inlet and outlet, which is actuable between an open condition in which fluid can flow in the fluid channel between the inlet and outlet and vice versa and a closed condition in which fluid is prevented from flowing in the fluid channel between the inlet and outlet and vice versa; a first biasing means arranged to act on the first inertia mass in a first direction away from the fluid channel closure; and a second biasing means arranged to act on the second inertia mass in a second direction opposite from the first direction and away from the fluid channel closure; the method comprising the steps of: a) subjecting the fluid prevention device to an acceleration with a component parallel to the either of the first or second directions; b) upon reaching an appropriate acceleration in the direction of the component, one of the first and second inertia masses acting on the fluid channel closure; c) the fluid channel closure moving from the open condition to the closed condition; d) upon a reduction in acceleration below the appropriate acceleration, the first or second inertia mass ceasing to act on the fluid channel; and e) the fluid channel closure returning to the open condition.

In this way, fluid is prevented from flowing in both directions, resulting in passive control of the fluid flow. As such, a passive method of complete fluid transmit prevention is provided.

### The First Control System

According to a further aspect of the invention, there is described a control system for controlling a brake system of a vehicle, the brake system comprising a brake fluid reservoir fluidically connected to a hydraulically actuated brake via an electromechanical valve, the control system comprising one or more processors collectively configured to:
determine or receive an acceleration signal comprising information indicative of a vehicle lateral acceleration;
determine whether the vehicle lateral acceleration is at or exceeds a predetermined threshold value; and
output a valve signal for actuating the electromechanical valve dependent on whether the vehicle lateral acceleration is at or exceeds the predetermined threshold valve.

Providing a control system to actuate the electromechanical valve dependent on the lateral acceleration of the vehicle may allow the flow of brake fluid through the system to be controlled and/or prevented based on the lateral acceleration of the vehicle.

Preferably, output the valve signal for actuating the electromechanical valve dependent on whether the vehicle lateral acceleration is at or exceeds the predetermined threshold valve so as to prevent fluid passing through the electromechanical valve.

Preferably, outputting of the valve signal for actuating the electromechanical valve dependent on whether the vehicle lateral acceleration is at or exceeds the predetermined threshold valve such that there is a reduction in the likelihood of knockback during a lateral acceleration event as the hydraulically actuated brake and brake fluid reservoir are fluidly disconnected.

The vehicle lateral acceleration may be a transitory lateral acceleration. A transitory lateral acceleration is a lateral acceleration which acts upon the fluid transit prevention device in a lateral direction. The lateral direction may be a lateral direction relative to the normal position of the fluid transit prevention device or the vehicle or a sensor configured to sense acceleration in the vehicle or on or in the fluid transit prevention device in use. In other words, when in use the fluid transit prevention device is located in or on a vehicle, for example in a car, the lateral direction will be relative to the fluid transit prevention device when the vehicle is supported on a surface in an operational state (i.e. the vehicle is able to traverse along said surface under its own power being provided by an internal combustion engine or the like) and the lateral direction will be transverse to the fore-aft direction of the vehicle.

Transitory meaning non-permanent or acting for a period of time. As will be apparent a transitory acceleration will encompass both a constant acceleration applied for a period of time and an acceleration which changes across a period of time (e.g. oscillating, increasing, decreasing, sawtooth shaped, square shaped, sine wave shaped, etc).

Should such a vehicle be tipped on its side such that the wheels of said vehicle where no longer engaging the surface, e.g. the vehicle is on its side or upside down, this would not be a transitory lateral acceleration within the meaning of this application. In such a scenario, the acceleration due to gravity would be acting relative to the fluid transit prevention device located in the vehicle but would not be transitory. The acceleration will act in this scenario until the vehicle is returned to its ‘normal’ operational position. That being, for a four-wheeled car, all four wheels being engaged to the surface on which the car is supported.

In use the electromechanical valve is located between the hydraulically actuated brake and a brake fluid reservoir such that closing the device interrupts fluid transmission between the brake fluid reservoir and the hydraulically actuated brake when the device is in the closed position. Advantageously, this reduces the likelihood of knockback during a lateral acceleration event.

The location of the electromechanical valve in use differs from that of an anti-lock braking device or automated braking system (ABS) or brake assist. These type of devices or control systems work, for example, by actuating a master cylinder connected to a hydraulically actuated brake in order to rapidly apply and remove braking pressure to a brake disc to regain traction control in the case of a skid or prevent wheel lock up. These systems do not operate in the same way as the present invention as the skilled reader will understand.

The one or more processors may be configured to control the electromechanical valve.

Preferably, the electromechanical valve is a solenoid valve.

Optionally, the electromechanical valve may be any valve capable of control by the one or more processors or a valve signal. For example, the valve may be a vacuum driven valve or a pneumatic valve. Optionally, the pneumatic valve or vacuum driven valve may be actuated by a pilot valve.

Optionally, the one or more processors are collectively configured to determine whether an operating condition is met, the operating condition requires at least that the vehicle lateral acceleration is a transitory vehicle lateral acceleration and the one or more processors are configured to determine whether the vehicle lateral acceleration is a transitory vehicle lateral acceleration, and
in response to determining that the vehicle lateral acceleration exceeds a predetermined threshold value and the operating condition is met, output the valve signal for actuating the electromechanical valve.

By determining whether the lateral acceleration is transitory or not, the control system may reduce the likelihood of the control system causing the valve to close in situations where it is not required, for example where the vehicle has tipped on its side (car door facing the ground and wheels not being supported by the floor) there will be a lateral acceleration under the effect of gravity. However, this lateral acceleration is not transitory in nature and will last until such a time that the vehicle is returned to its normal position, that being with the wheels engaged upon the ground. In such a scenario it may be useful to not have the valve closed.

Optionally or additionally, the one or more processors are collectively configured to:
determine or receive a vehicle state signal comprising information indicative of a current state of the vehicle;
determine in dependence upon the vehicle state signal that the vehicle is in a moving state indicating that the vehicle is moving along a surface on which the vehicle is supported wherein one or more of the wheels of the vehicle are engaged with said surface;
determine whether an operating condition is met, the operating condition requires the vehicle is in the moving state; and
in response to determining that the vehicle lateral acceleration exceeds a predetermined threshold value and the operating condition is met, output the valve signal for actuating the electromechanical valve.

Such a determination can aid in determining whether the lateral acceleration is transitory or not, the control system may reduce the likelihood of the control system causing the valve to close in situations where it is not required, for example where the vehicle has tipped on its side (car door facing the ground and wheels not being supported by the surface on which the vehicle is travelling along) there will be a lateral acceleration under the effect of gravity. However, this lateral acceleration is not transitory in nature and will last until such a time that the vehicle is returned to its normal position, that being with the wheels engaged upon the ground. In such a scenario it may be useful to not have the valve closed.

Optionally, in response to determining that the vehicle lateral acceleration exceeds a predetermined threshold value and the operating condition is not met the valve signal for actuating the electromechanical valve dependent on whether the vehicle lateral acceleration exceeds the predetermined threshold value is not output.

Optionally, in response to determining that the vehicle lateral acceleration does not exceed a predetermined threshold value and the operating condition is not met the valve signal for actuating the electromechanical valve dependent on whether the vehicle lateral acceleration exceeds the predetermined threshold value is not output.
Optionally, wherein the valve signal is configured to open the electromechanical valve when the vehicle acceleration is below the predetermined threshold value, and wherein the valve signal is configured to close the electromechanical valve when the vehicle acceleration is at or exceeds the predetermined threshold value.

Configuring the control system to close the electromechanical valve may prevent the flow of brake fluid back through the system when lateral acceleration exceeds a predetermined threshold value.

Optionally, wherein the one or more processors are further collectively configured to:
determine or receive a valve position signal comprising information indicative of the position of the electromechanical valve;
determine, based on a determination that the vehicle lateral acceleration does not exceed the predetermined threshold value, whether the electromechanical valve is in an open or closed position; and
output a delay signal for delaying opening of the electromechanical valve if the valve is in the closed position.

Delaying opening of the electromechanical valve when the lateral acceleration of the vehicle is below the threshold value may be beneficial because such a delay may enable any positive residual pressure to decrease and promote seal roll back of the valve seal as the valve may have elastic performance dependent upon as time as a function.

Optionally, wherein the delay signal is configured to delay actuation of the electromechanical valve by at least 0.5 seconds to 10 seconds, preferably by at least 2 seconds, further preferably by at least 1 second.

Delaying the actuation of the electromechanical valve until a set time after the lateral acceleration event may reduce the likelihood of hydraulic hammering or hydraulic shock as a result of opening the valve and the brake fluid still being energised from the lateral acceleration event.

Optionally, wherein the one or more processors are further collectively configured to:
receive a driver input signal comprising information indicative of a driver brake request, wherein the delay signal is configured to request closure of the electromechanical valve when a driver brake request is received.

This arrangement may be beneficial when the vehicle is driving along a course where there are a series of sharp corners one-after-the-other. This reduces the need to open and close the solenoid repeatably which can be energy intensive whilst the vehicle is braking.

Optionally, wherein the one or more processors are further collectively configured to:
determine or receive a vehicle parameter signal comprising information indicative of one or more of: brake application, steering angle, vehicle roll angle, GPS data, vehicle speed, and suspension height;
determine, based on the information contained within the vehicle parameter signal, whether a lateral acceleration event has begun or whether a lateral acceleration event is likely to begin;
output the valve signal based on a determination that a lateral acceleration event has begun; or
output the valve signal based on a determination that a lateral acceleration event is likely to begin; or
output, based on a determination that a lateral acceleration event has not begun, an override signal for opening the electromechanical valve; and/or
do not output the valve signal based on a determination that a lateral acceleration event has not begun.

In some driving conditions a lateral acceleration sensor may yield a false positive result indicating that a lateral acceleration event has begun, for example where the vehicle traverses a bank, and the lateral acceleration sensor may misinterpret gravity as a lateral acceleration event. In this case the electromechanical valve should remain open, and as such it is beneficial to provide a control system capable of determining whether an acceleration event has begun based on other vehicle information as listed above.

GPS data may be used to determine locations on a course where there is a high likelihood of a lateral acceleration event taking place (e.g. locations with long corners) and where there is a low likelihood of a lateral acceleration event taking place (e.g. pit lane which tend to be straight). As such the control system may determine in dependence upon the GPS data whether a lateral acceleration event has begun or whether it is more likely some other event has occurred (such as lateral side loading in the event of a crash).

The GPS data may be used to determine whether a lateral acceleration event is likely to begin. For example, where the vehicle is located on a track or course with a series of high-speed high angle turns there is a likelihood that a lateral acceleration event is likely to begin. This information may be pre-loaded in a memory that is readable by the control system. Alternatively, the control system may determine, on-the-fly, whether a lateral acceleration event is likely to occur by comparing a pre-loaded course map with GPS data stored in the memory.

Optionally, the control system is further configured to not output the valve signal based on a determination that a lateral acceleration event is not likely to begin.

Optionally, the control system determines whether a lateral acceleration event is likely to begin within a pre-determined time period.

In such a case the pre-determined time period may be 0.1 to 10 seconds or 1 to 5 seconds or 3 seconds before the vehicle reaches the location of the likely lateral acceleration event. Alternatively, the pre-determined time period may be determined on-the-fly in real time by the control system. The control system may determine in dependence upon the GPS and vehicle speed a likely time period for the vehicle to reach the lateral acceleration event. Optionally, the pre-determined time period may be updated as the vehicle speed changes.

The steering angle and/or vehicle speed may be used to determine whether a lateral acceleration event has begun. For example, a lateral acceleration event may be determined to have begun where there is a scenario with a high steering angle (e.g. greater or equal to 90 degrees) and a low vehicle speed (e.g. less than or equal to 10 kph) or a scenario with a low steering angle (e.g. less than 45 degrees) and a high vehicle speed (e.g. greater than 60 kph). The valve actuation threshold can be a HIGH steering angle and a LOW vehicle speed or a LOW steering angle and a HIGH vehicle speed. The relationship between steering angle and vehicle speed may be an inversely proportional relationship.

Steering angle may be used to determine whether a lateral acceleration event has likely to have begun. For example, if the steering angle is 0 degrees (steering wheel at a 12 o'clock position) then the vehicle is likely not to be experiencing a lateral acceleration event as it is likely the vehicle is going in a straight line forward. Should the steering angle be 45 to 90 degrees +/−0 degrees, e.g. between the 01:30 and 03:00 or 09:00 to 10:30 position, then the vehicle will be turning and as a result is more likely to be undertaking a lateral acceleration event. The actual implemented steering angle may depend upon the steering rack ratio of the vehicle the control system is employed upon.

The vehicle parameter signal may be sensed by a sensor, for example, in the case of a vehicle speed, the vehicle speed may be determined by a wheel speed sensor or tachometer or other suitable sensor.

The suspension height, determined by a suspension height transducer(s) (for example) can be used to determine the vehicle's loading condition. For a greater the vehicle mass (e.g. when the vehicle has a full fuel tank) would require a lower lateral acceleration threshold valve closing point (as opposed to a vehicle having a quarter full fuel tank). Additional consumable mass (fuel for example) multiplied by a given lateral acceleration produces a higher reactive force through the suspension and may produce greater knockback in the braking system in practice.

A lateral acceleration event may be determined to be likely to begin when the user requests braking. The brake request indicates that the user is or is not requesting a brake to be applied. The brake request may be sensed by a brake sensor, such as a brake switch sensor or a brake hydraulic fluid pressure sensor or a brake master cylinder travel sensor. By pre-emptively outputting a request to close the valve the vehicle in which the control system is located in can pre-empt driving conditions with the driver's input.

Optionally, the control system determines whether a lateral acceleration event is likely to begin within a pre-determined time period.

In such a case the pre-determined time period may be 0.1 to 10 seconds or 1 to 5 seconds or 3 seconds from the brake request. Alternatively, the pre-determined time period may be determined on-the-fly in real time by the control system. The control system may determine in dependence upon the GPS and vehicle speed a likely time period for the vehicle to traverse the lateral acceleration event. Optionally, the pre-determined time period may be updated as the vehicle speed changes.

Optionally, wherein the one or more processors are further collectively configured to:
determine that the vehicle speed is 0 kph in dependence upon the vehicle parameter signal, and output an override signal for opening the electromechanical valve.

The logic causes the valve to remain open in situations where the vehicle is for example stationary in the pit lane and therefore may enable maintenance to be undertaken, for example bleeding of brakes.

Optionally, wherein the one or more processors are further collectively configured to:
determine that the vehicle is located in a maintenance area in dependence upon the vehicle parameter signal and output an override signal for opening the electromechanical valve.

The logic causes the valve to remain open in situations where the vehicle is located in a maintenance area (such as a pit lane or garage) and therefore may enable maintenance to be undertaken, for example bleeding of brakes.

Optionally, wherein the one or more processors are further collectively configured to:
determine that the vehicle is located in a maintenance area and the vehicle speed is 0 kph in dependence upon the vehicle parameter signal, and output an override signal for opening the electromechanical valve.

Such an option may be useful in race situations where there are known maintenance areas on the course and it would be preferable to enable brake bleeding in such areas without manually overriding the control system to open the valve.

According to a further aspect of the invention, there is described a brake system comprising the control system and a brake circuit, the brake fluid circuit comprising: a brake fluid reservoir, a hydraulically actuated brake and an electromechanical valve;
wherein the electromechanical valve is located between the brake fluid reservoir and the hydraulically actuated brake;
the electromechanical valve being actuatable between an open position configured to fluidly connect the brake fluid reservoir and the hydraulically actuated brake, and a closed position to fluidly disconnect the brake fluid reservoir and the hydraulically actuated brake.

Optionally, wherein the electromechanical valve is biased towards the open position. Optionally, wherein the electromechanical valve is biased to the open position.

Biasing the valve towards the open position may increase the likelihood of brake fluid being permitted to flow from the brake fluid reservoir to the hydraulically actuated brake during normal operating conditions of the vehicle. The biasing means may be a spring.

Optionally, wherein the brake system further comprises a volume compliance chamber fluidically connected to the hydraulically actuated brake and configured to maintain fluid pressure and/or brake fluid volume within the brake system.

Providing the volume compliance chamber to maintain fluid pressure may improve brake performance during a lateral acceleration event where the valve is closed to prevent back-flow of brake fluid and the hydraulically actuated brakes are requested to be applied by the user of the vehicle.

Optionally, wherein the volume compliance chamber has a first configuration with a first volume and a second configuration with a second volume, the first volume being greater than the second volume.

The volume compliance chamber may be configured to move between the first configuration and second configuration depending on the fluid pressure within the brake system. In this was the volume compliance chamber may act passively to maintain the fluid pressure within the brake system when the valve is in the closed position. This reduces likelihood of brake line pressure losses when a braking event is demanded by the user.

Optionally, wherein the volume compliance chamber is biased to the second configuration. Biasing to the second configuration causes brake fluid to be forced out of the volume compliance chamber and into brake fluid circuit.

According to a yet further aspect of the invention, there is described a vehicle comprising the brake system of any embodiment of the aspect describing the brake system or the control system of any embodiment of the aspect describing the control system. Preferably, the vehicle may be any one of a car, motorcycle, sport car, rally car, supercar, hypercar, coupé, Sports Utility Vehicle (SUV), an open-wheel single-seater formula racing car.

According to an even further aspect of the invention, there is described a method of controlling a brake system comprising a brake fluid reservoir fluidically connected to a hydraulically actuated brake via an electromechanical valve, the method comprising the steps of:
determining or receiving an acceleration signal comprising information indicative of a vehicle lateral acceleration;
determining whether the vehicle lateral acceleration is at or exceeds a predetermined threshold value; and
outputting a valve signal for actuating the electromechanical valve dependent on whether the vehicle lateral acceleration exceeds the predetermined threshold value.

Preferably, output the valve signal for actuating the electromechanical valve dependent on whether the vehicle lateral acceleration is at or exceeds the predetermined threshold valve so as to prevent fluid passing through the electromechanical valve.

Preferably, outputting of the valve signal for actuating the electromechanical valve dependent on whether the vehicle lateral acceleration is at or exceeds the predetermined threshold valve such that there is a reduction in the likelihood of knockback during a lateral acceleration event as the hydraulically actuated brake and brake fluid reservoir are fluidly disconnected.

Optionally, wherein the valve signal is configured to open the electromechanical valve when the vehicle acceleration is below the predetermined threshold value, and wherein the valve signal is configured to close the electromechanical valve when the vehicle acceleration is at or exceeds the predetermined threshold value.

Optionally, further comprising the steps of:
determining, based on the information contained within the vehicle parameter signal, whether a lateral acceleration event has begun or whether a lateral acceleration event is likely to begin;
outputting the valve signal based on a determination that a lateral acceleration event has begun; or
outputting the valve signal based on a determination that a lateral acceleration event is likely to begin; or
outputting, based on a determination that a lateral acceleration event has not begun, an override signal for opening the electromechanical valve; and/or
not outputting the valve signal based on a determination that a lateral acceleration event has not begun.

Optionally, the method is further comprises the step of not outputting the valve signal based on a determination that a lateral acceleration event is not likely to begin.

The method may comprise any other optional or additional steps as described in any of the previous aspects of the invention, for example, the method may comprise additional steps as described in the aspect of the invention describing the control system.

According to a yet even further aspect of the invention, there is described a computer-readable storage medium comprising instructions which, when executed by a computer, cause the computer to carry out the method as described by any embodiment of the aspect describing the method.

### The Second Control System

A second control system will now be described.

According to an additional aspect of the invention, there is described a control system for controlling a brake system of a vehicle, the brake system comprising a brake fluid reservoir fluidically connected to a hydraulically actuated brake via an electromechanical valve, the control system comprising one or more processors collectively configured to:
determine or receive a vehicle parameter signal comprising information indicative of a brake request;
determine, based on the information contained within the vehicle parameter signal, whether a lateral acceleration event has begun or whether a lateral acceleration event is likely to begin;
output a valve signal for actuating the electromechanical valve based on a determination that a lateral acceleration event has begun or is likely to begin.

Preferably, output the valve signal for actuating the electromechanical valve based on a determination that a lateral acceleration event has begun or is likely to begin so as to prevent fluid passing through the electromechanical valve.

Preferably, outputting the valve signal for actuating the electromechanical valve based on a determination that a lateral acceleration event has begun or is likely to begin such that there is a reduction in the likelihood of knockback during a lateral acceleration event as the hydraulically actuated brake and brake fluid reservoir are fluidly disconnected.

Optionally, the vehicle parameter signal further comprises information indicative of one or more of: steering angle, vehicle roll angle, GPS data, vehicle speed, vehicle lateral acceleration and suspension height.

Providing a control system to actuate the electromechanical valve dependent on a lateral acceleration event has begun or is likely to being enables greater control of the flow of brake fluid through the system to be controlled and/or prevented based on the lateral acceleration of the vehicle. This reduces the likelihood of knockback during long corners at speed, for example, or where the vehicle is traversing a chicane, movement of fluid in a fore-and-aft or left-and-right direction (for example).
By taking into account a brake request (e.g. a signal determined by a sensor or circuit connected to a brake pedal or a controller of a brake pedal indicating that the driver has modulated a brake pedal to request application of the brakes) the control system can pre-emptively determine that a lateral acceleration event is likely to occur. This is because it is common for the driver of a vehicle to request application of the brakes prior to traversing a corner in order to decelerate the vehicle before reaching the corner itself or the apex of said corner.

According to a yet additional aspect of the invention, there is described a control system for controlling a brake system of a vehicle, the brake system comprising a brake fluid reservoir fluidically connected to a hydraulically actuated brake via an electromechanical valve, the control system comprising one or more processors collectively configured to:
determine or receive a vehicle parameter signal comprising information indicative of one or more of: a brake request, steering angle, vehicle roll angle, GPS data, vehicle speed, vehicle lateral acceleration and suspension height;
determine, based on the information contained within the vehicle parameter signal, whether a lateral acceleration event has begun or whether a lateral acceleration event is likely to begin;
output a valve signal for actuating the electromechanical valve based on a determination that a lateral acceleration event has begun or is likely to begin.

Preferably, output the valve signal for actuating the electromechanical valve based on a determination that a lateral acceleration event has begun or is likely to begin so as to prevent fluid passing through the electromechanical valve.

Preferably, outputting the valve signal for actuating the electromechanical valve based on a determination that a lateral acceleration event has begun or is likely to begin such that there is a reduction in the likelihood of knockback during a lateral acceleration event as the hydraulically actuated brake and brake fluid reservoir are fluidly disconnected.

GPS data may be used to determine locations on a course where there is a high likelihood of a lateral acceleration event taking place (e.g. locations with long or sharp corners) and where there is a low likelihood of a lateral acceleration event taking place (e.g. pit lane which tend to be straight). As such the control system may determine in dependence upon the GPS data whether a lateral acceleration event has begun or whether it is more likely some other event has occurred (such as lateral side loading in the event of a crash).

The GPS data may be used to determine whether a lateral acceleration event is likely to begin. For example, where the vehicle is located on a track or course with a series of high-speed high angle turns there is a likelihood that a lateral acceleration event is likely to begin. This information may be pre-loaded in a memory that is readable by the control system. Alternatively, the control system may determine, on-the-fly, whether a lateral acceleration event is likely to occur by comparing a pre-loaded course map with GPS data stored in the memory.

Steering angle may be used to determine whether a lateral acceleration event is occurring or is likely to being. For example, where the steering angle is above a threshold value, or remains above a threshold value for a period of time, or there is an increase or decrease in steering angle greater than a threshold steering angle change.

Vehicle roll angle may be used to determine whether a lateral acceleration event is occurring or is likely to begin. For example, where there is a change in roll angle above a threshold value.

Vehicle speed may be used to determine whether a lateral acceleration is occurring or is likely to begin. For example, where there is a change in vehicle speed above a threshold speed value.

Vehicle lateral acceleration may be used to determine whether a lateral acceleration is occurring or is likely to occur. For example where the vehicle lateral acceleration is at or exceeds a threshold value, or where there is an increase of vehicle lateral acceleration greater than or equal to a threshold rate.

Suspension height may be used to determine whether a lateral acceleration event is occurring or is likely to begin. For example, where there is a change in suspension height above a threshold value.

The vehicle lateral acceleration may be a transitory lateral acceleration. A transitory lateral acceleration is a lateral acceleration which acts upon the fluid transit prevention device in a lateral direction. The lateral direction may be a lateral direction relative to the normal position of the fluid transit prevention device or the vehicle or a sensor configured to sense acceleration in the vehicle or on or in the fluid transit prevention device in use. In other words, when in use the fluid transit prevention device is located in or on a vehicle, for example in a car, the lateral direction will be relative to the fluid transit prevention device when the vehicle is supported on a surface in an operational state (i.e. the vehicle is able to traverse along said surface under its own power being provided by an internal combustion engine or the like) and the lateral direction will be transverse to the fore-aft direction of the vehicle.

Transitory meaning non-permanent or acting for a period of time. As will be apparent a transitory acceleration will encompass both a constant acceleration applied for a period of time and an acceleration which changes across a period of time (e.g. oscillating, increasing, decreasing, sawtooth shaped, square shaped, sine wave shaped, etc).

In use the electromechanical valve is located between the hydraulically actuated brake and a brake fluid reservoir such that closing the device interrupts fluid transmission between the brake fluid reservoir and the hydraulically actuated brake when the device is in the closed position. Advantageously, this reduces the likelihood of knockback during a lateral acceleration event.

The location of the electromechanical valve in use differs from that of an anti-lock braking device or automated braking system (ABS) or brake assist. These type of devices or control systems work, for example, by actuating a master cylinder connected to a hydraulically actuated brake in order to rapidly apply and remove braking pressure to a brake disc to regain traction control in the case of a skid or prevent wheel lock up. These systems do not operate in the same way as the present invention as the skilled reader will understand.

Should such a vehicle be tipped on its side such that the wheels of said vehicle where no longer engaging the surface, e.g. the vehicle is on its side or upside down, this would not be a transitory lateral acceleration within the meaning of this application. In such a scenario, the acceleration due to gravity would be acting relative to the fluid transit prevention device located in the vehicle but would not be transitory. The acceleration will act in this scenario until the vehicle is returned to its ‘normal’ operational position. That being, for a four-wheeled car, all four wheels being engaged to the surface on which the car is supported.

According to the additional aspect of the invention or the yet additional aspect of the invention additional or optional features may be provided as detailed in the embodiments below.

The one or more processors may be configured to control the electromechanical valve.

Preferably, the electromechanical valve is a solenoid valve.

Optionally, the electromechanical valve may be any valve capable of control by the one or more processors or a valve signal. For example, the valve may be a vacuum driven valve or a pneumatic valve. Optionally, the pneumatic valve or vacuum driven valve may be actuated by a pilot valve.

Optionally, the one or more processors are collectively configured to determine whether an operating condition is met, the operating condition requires at least that the lateral acceleration event has begun and the vehicle lateral acceleration is a transitory vehicle lateral acceleration, wherein the one or more processors are configured to determine whether the vehicle lateral acceleration is a transitory vehicle lateral acceleration, and in response to determining that a lateral acceleration event has begun or is likely to begin and the operating condition is met, output the valve signal for actuating the electromechanical valve.

By determining whether the lateral acceleration is transitory or not, the control system may reduce the likelihood of the control system causing the valve to close in situations where it is not required, for example where the vehicle has tipped on its side (car door facing the ground and wheels not being supported by the floor) there will be a lateral acceleration under the effect of gravity. However, this lateral acceleration is not transitory in nature and will last until such a time that the vehicle is returned to its normal position, that being with the wheels engaged upon the ground. In such a scenario it may be useful to not have the valve closed.

Optionally or additionally, the one or more processors are collectively configured to: determine or receive a vehicle state signal comprising information indicative of a current state of the vehicle;
determine in dependence upon the vehicle state signal that the vehicle is in a moving state indicating that the vehicle is moving along a surface on which the vehicle is supported wherein one or more of the wheels of the vehicle are engaged with said surface;
determine whether an operating condition is met, the operating condition requires the vehicle is in the moving state; and
in response to determining that that a lateral acceleration event has begun or is likely to begin and the operating condition is met, output the valve signal for actuating the electromechanical valve.

Such a determination can aid in determining whether the lateral acceleration is transitory or not, the control system may reduce the likelihood of the control system causing the valve to close in situations where it is not required, for example where the vehicle has tipped on its side (car door facing the ground and wheels not being supported by the surface on which the vehicle is travelling along) there will be a lateral acceleration under the effect of gravity. However, this lateral acceleration is not transitory in nature and will last until such a time that the vehicle is returned to its normal position, that being with the wheels engaged upon the ground. In such a scenario it may be useful to not have the valve closed.

Optionally, in response to determining that a lateral acceleration event has begun or is likely to begin and the operating condition is not met the valve signal is not output. Optionally, in response to determining that a lateral acceleration event has not begun or is not likely to begin and the operating condition is not met the valve signal is not output.

Optionally, the control system comprising one or more processors is further collectively configured to:
determine or receive an acceleration signal comprising information indicative of a vehicle lateral acceleration;
determine whether the vehicle lateral acceleration is at or exceeds a predetermined threshold value; and output the valve signal for actuating the electromechanical valve dependent on whether the vehicle lateral acceleration exceeds the predetermined threshold value.

Optionally, wherein the valve signal is configured to open the electromechanical valve when the vehicle acceleration is below the predetermined threshold value, and wherein the valve signal is configured to close the electromechanical valve when the vehicle acceleration is at or exceeds the predetermined threshold value.

Optionally, the control system is further configured to determine whether the vehicle lateral acceleration is at or exceeds a predetermined threshold value in dependence upon the vehicle parameter signal.

Optionally, the control system determines whether a lateral acceleration event is likely to begin within a pre-determined time period.

In such a case the pre-determined time period may be 0.1 to 10 seconds or 1 to 5 seconds or 3 seconds before the vehicle reaches the location of the likely lateral acceleration event. Alternatively, the pre-determined time period may be determined on-the-fly in real time by the control system. The control system may determine in dependence upon the GPS and vehicle speed a likely time period for the vehicle to reach the lateral acceleration event. Optionally, the pre-determined time period may be updated as the vehicle speed changes.

The steering angle and/or vehicle speed may be used to determine whether a lateral acceleration event has begun. For example, a lateral acceleration event may be determined to have begun where there is a scenario with a high steering angle (e.g. greater or equal to 90 degrees) and a low vehicle speed (e.g. less than or equal to 10 kph) or a scenario with a low steering angle (e.g. less than 45 degrees) and a high vehicle speed (e.g. greater than 60 kph). The valve actuation threshold can be a HIGH steering angle and a LOW vehicle speed or a LOW steering angle and a HIGH vehicle speed. The relationship between steering angle and vehicle speed may be an inversely proportional relationship.

Steering angle may be used to determine whether a lateral acceleration event has likely to have begun. For example, if the steering angle is 0 degrees (steering wheel at a 12 o'clock position) then the vehicle is likely not to be experiencing a lateral acceleration event as it is likely the vehicle is going in a straight line forward. Should the steering angle be 45 to 90 degrees +/−0 degrees, e.g. between the 01:30 and 03:00 or 09:00 to 10:30 position, then the vehicle will be turning and as a result is more likely to be undertaking a lateral acceleration event. The actual implemented steering angle may depend upon the steering rack ratio of the vehicle the control system is employed upon.

The vehicle parameter signal may be sensed by a sensor, for example, in the case of a vehicle speed, the vehicle speed may be determined by a wheel speed sensor or tachometer or other suitable sensor.

The suspension height, determined by a suspension height transducer(s) (for example) can be used to determine the vehicle's loading condition. For a greater the vehicle mass (e.g. when the vehicle has a full fuel tank) would require a lower lateral acceleration threshold valve closing point (as opposed to a vehicle having a quarter full fuel tank). Additional consumable mass (fuel for example) multiplied by a given lateral acceleration produces a higher reactive force through the suspension and may produce greater knockback in the braking system in practice.

A lateral acceleration event may be determined to be likely to begin when the user requests braking. The brake request indicates that the user is or is not requesting a brake to be applied. The brake request may be sensed by a brake sensor, such as a brake switch sensor or a brake hydraulic fluid pressure sensor or a brake master cylinder travel sensor. By pre-emptively outputting a request to close the valve the vehicle in which the control system is located in can pre-empt driving conditions with the driver's input.

Optionally, the control system determines whether a lateral acceleration event is likely to begin within a pre-determined time period.

In such a case the pre-determined time period may be 0.1 to 10 seconds or 1 to 5 seconds or 3 seconds from the brake request. Alternatively, the pre-determined time period may be determined on-the-fly in real time by the control system. The control system may determine in dependence upon the GPS and vehicle speed a likely time period for the vehicle to traverse the lateral acceleration event. Optionally, the pre-determined time period may be updated as the vehicle speed changes.

Optionally, wherein the one or more processors are further collectively configured to:
determine that the vehicle speed is 0 kph in dependence upon the vehicle parameter signal, and output an override signal for opening the electromechanical valve.

The logic causes the valve to remain open in situations where the vehicle is located in the pit lane and therefore may enable maintenance to be undertaken, for example bleeding of brakes.

Optionally, wherein the one or more processors are further collectively configured to:
determine that the vehicle is located in a pit lane in dependence upon the vehicle parameter signal, and output an override signal for opening the electromechanical valve.

The logic causes the valve to remain open in situations where the vehicle is located in the pit lane and therefore may enable maintenance to be undertaken, for example bleeding of brakes.

Optionally, wherein the one or more processors are further collectively configured to:
determine that the vehicle is located in a pit lane and the vehicle speed is 0 kph in dependence upon the vehicle parameter signal, and output an override signal for opening the electromechanical valve.

Optionally, output, based on a determination that a lateral acceleration event has not begun, an override signal for opening the electromechanical valve.

Optionally, the one or more processors do not output, based on a determination that a lateral acceleration event has not begun, the valve signal.

In some driving conditions a lateral acceleration sensor may yield a false positive result indicating that a lateral acceleration event has begun, for example where the vehicle traverses a bank, and the lateral acceleration sensor may misinterpret gravity as a lateral acceleration event. In this case the electromechanical valve should remain open, and as such it is beneficial to provide a control system capable of determining whether an acceleration event has begun based on other vehicle information as listed above.

Optionally, the control system is further configured to not output the valve signal based on a determination that a lateral acceleration event is not likely to begin.

Optionally, wherein the one or more processors are further collectively configured to:
determine or receive a valve position signal comprising information indicative of the position of the electromechanical valve;
determine, based on a determination that the vehicle lateral acceleration does not exceed the predetermined threshold value, whether the electromechanical valve is in an open or closed position; and
output a delay signal for delaying opening of the electromechanical valve if the valve is in the closed position.

Delaying opening of the electromechanical valve when the lateral acceleration of the vehicle is below the threshold value may be beneficial because such a delay may enable any positive residual pressure to decrease and promote seal role back of the valve seal as the valve may have elastic performance dependent upon as time as a function.

Optionally, wherein the delay signal is configured to delay actuation of the electromechanical valve by at least 0.5 seconds to 10 seconds, preferably by at least 2 seconds, further preferably by at least 1 second.

Delaying the actuation of the electromechanical valve until a set time after the lateral acceleration event may reduce the likelihood of hydraulic hammering or hydraulic shock as a result of opening the valve and the brake fluid still being energised from the lateral acceleration event.

According to a yet more additional aspect of the invention, there is described a brake system comprising the control system and a brake circuit, the brake fluid circuit comprising: a brake fluid reservoir, a hydraulically actuated brake and an electromechanical valve;
wherein the electromechanical valve is located between the brake fluid reservoir and the hydraulically actuated brake; the electromechanical valve being actuatable between an open position configured to fluidly connect the brake fluid reservoir and the hydraulically actuated brake, and a closed position to fluidly disconnect the brake fluid reservoir and the hydraulically actuated brake.

Optionally, wherein the electromechanical valve is biased towards the open position.

Optionally, wherein the electromechanical valve is biased to the open position.

Biasing the valve towards the open position may increase the likelihood of brake fluid being permitted to flow from the brake fluid reservoir to the hydraulically actuated brake during normal operating conditions of the vehicle. The biasing means may be a spring.

Optionally, wherein the brake system further comprises a volume compliance chamber fluidically connected to the hydraulically actuated brake and configured to maintain fluid pressure and/or brake fluid volume within the brake system.

Providing the volume compliance chamber to maintain fluid pressure may improve brake performance during a lateral acceleration event where the valve is closed to prevent back-flow of brake fluid and the hydraulically actuated brakes are requested to be applied by the user of the vehicle.

Optionally, wherein the volume compliance chamber has a first configuration with a first volume and a second configuration with a second volume, the first volume being greater than the second volume.

The volume compliance chamber may be configured to move between the first configuration and second configuration depending on the fluid pressure within the brake system. In this was the volume compliance chamber may act passively to maintain the fluid pressure within the brake system when the valve is in the closed position. This reduces likelihood of brake line pressure losses when a braking event is demanded by the user.

Optionally, wherein the volume compliance chamber is biased to the second configuration. Biasing to the second configuration causes brake fluid to be forced out of the volume compliance chamber and into brake fluid circuit.

According to a yet more further additional aspect of the invention, there is described a vehicle comprising the brake system of any embodiment of the aspect describing the brake system or the control system of any embodiment of the aspect describing the control system. Preferably, the vehicle may be any one of a car, motorcycle, sport car, rally car, supercar, hypercar, coupé, Sports Utility Vehicle (SUV), an open-wheel single-seater formula racing car.

According to an additional even further aspect of the invention, there is described a method of controlling a brake system comprising a brake fluid reservoir fluidically connected to a hydraulically actuated brake via an electromechanical valve, the method comprising:
determining or receiving a vehicle parameter signal comprising information indicative of a brake request;
determining, based on the information contained within the vehicle parameter signal, whether a lateral acceleration event has begun or whether a lateral acceleration event is likely to begin;
outputting a valve signal for actuating the electromechanical valve based on a determination that a lateral acceleration event has begun or is likely to begin.

Preferably, output the valve signal for actuating the electromechanical valve based on a determination that a lateral acceleration event has begun or is likely to begin so as to prevent fluid passing through the electromechanical valve.

Preferably, outputting the valve signal for actuating the electromechanical valve based on a determination that a lateral acceleration event has begun or is likely to begin such that there is a reduction in the likelihood of knockback during a lateral acceleration event as the hydraulically actuated brake and brake fluid reservoir are fluidly disconnected.

The method may comprise any other optional or additional steps as described in any of the previous aspects of the invention, for example, the method may comprise additional steps as described in the aspect of the invention describing the control system.

According to a yet more even further aspect of the invention, there is described a computer-readable storage medium comprising instructions which, when executed by a computer, cause the computer to carry out the method as described by any embodiment of the aspect describing the method.

The features of the first and second control system may be combined with each other, such that the first control system comprises additional features of the second control system or vice versa without departing from the scope of the present disclosure.

As will be apparent to the skilled reader of the present disclosure, a vehicle according to the present invention may comprise any combination of the fluid transit prevention device and/or fluid brake system and/or a control system and/or brake system and/or a second control system and/or a second brake system. The vehicle may comprise both a mechanical valve described by the fluid transit prevention device or fluid brake system as described above as well as a control system and/or brake system and/or a second control system and/or a second brake system as described above. Such an arrangement may enable multiple means to prevent knockback on the same vehicle.

As will be apparent various modifications may be made without departing from the scope of the invention.

### BRIEF DESCRIPTION OF THE DRAWINGS

Embodiments will now be described, by way of example only, with reference to the accompanying figures in which:

FIG. 1 is a perspective view of a device according to a first embodiment of the present invention;

FIG. 2 is a side view of the device of FIG. 1;

FIG. 3 is an end view of the device of FIG. 1;

FIG. 4 is a bottom view of the device of FIG. 1;

FIG. 5 is a top view of the device of FIG. 1;

FIG. 6 is a side section view of the joining portion of the device of FIG. 1;

FIG. 7 is a perspective view of a valve assembly of the device of FIG. 1;

FIG. 8 is a side section view of the valve assembly of FIG. 7;

FIG. 9 is partial section view of the device of FIG. 1;

FIG. 10 is a circuit diagram of a fluid brake system according to the present invention;

FIG. 11 is a side section view of the device of FIG. 1 in a passive state;

FIG. 12 is a side section view of the device of FIG. 1 in a first state;

FIG. 13 is a side section view of the device of FIG. 1 in a second state;

FIG. 14 is a diagrammatic view of a device according to a second embodiment of the present invention in a passive state;

FIG. 15 is a diagrammatic view of the device of FIG. 14 in a first state;

FIG. 16 is a diagrammatic view of the device of FIG. 14 in a second state;

FIG. 17 is a diagrammatic view of a device according to a third embodiment of the present invention in a passive state;

FIG. 18 is a diagrammatic view of the device of FIG. 17 in a first state;

FIG. 19 is a diagrammatic view of the device of FIG. 17 in a second state;

FIG. 20 is a diagrammatic view of a device according to a fourth embodiment of the present invention in a passive state;

FIG. 21 is a schematic view of a sub-system of a vehicle, the sub-system having a control system for controlling an electromechanical valve, in accordance with an embodiment of the invention;

FIG. 22 is a schematic view of a fluid circuit of the sub-system of FIG. 21;

FIG. 23 is a schematic showing a control system according to an embodiment of the invention;

FIG. 24 is a flow chart describing steps for determining whether to close an electromechanical valve in accordance with an embodiment of the invention;

FIG. 25 is a flow chart describing steps for determining whether to close an electromechanical valve in accordance with an embodiment of the invention; and FIG. 26 is a flow chart describing steps for determining whether to close an electromechanical valve in accordance with an embodiment of the invention.

### DETAILED DESCRIPTION OF EMBODIMENTS

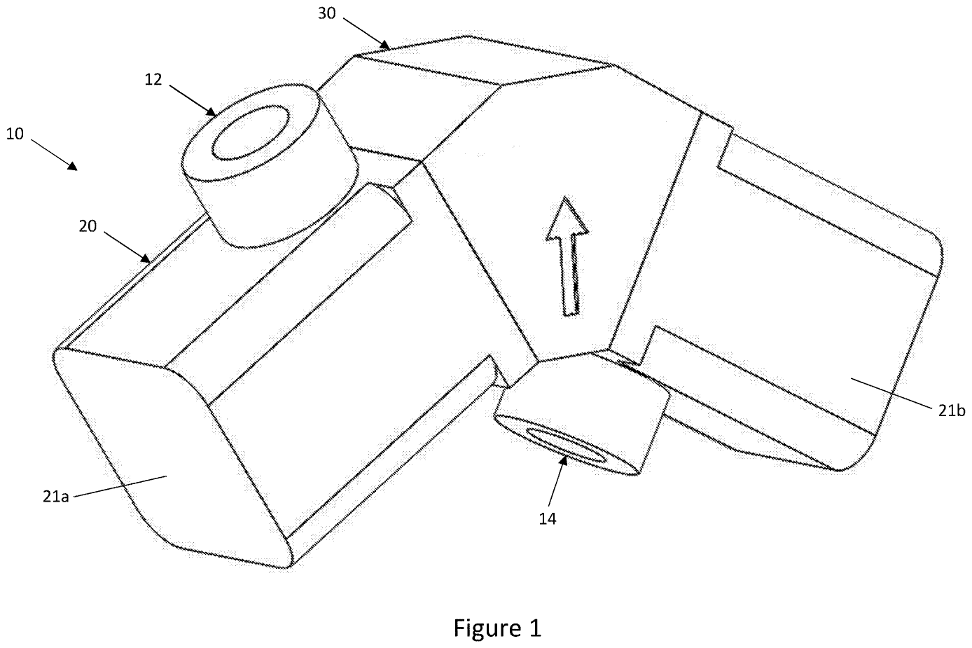

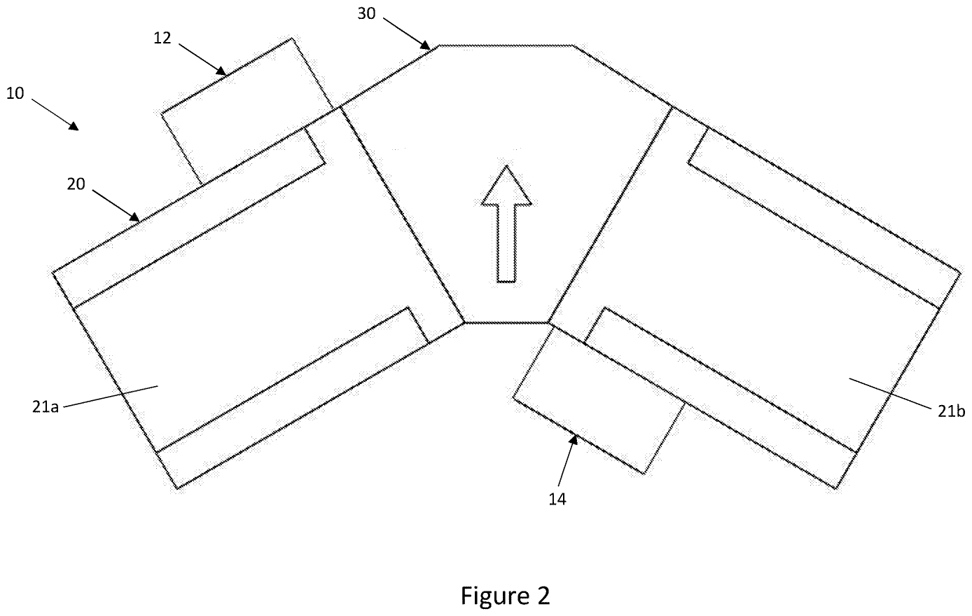

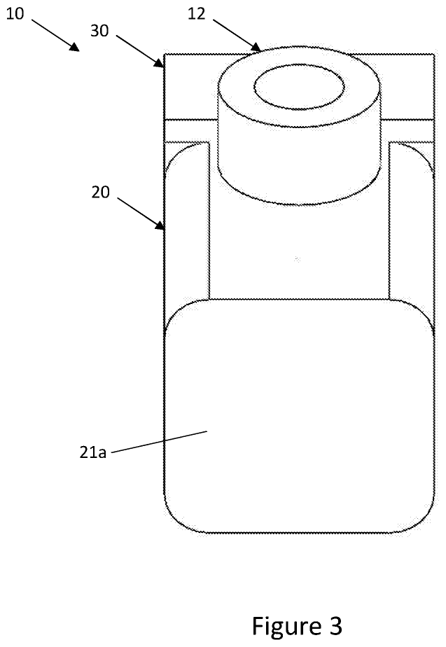

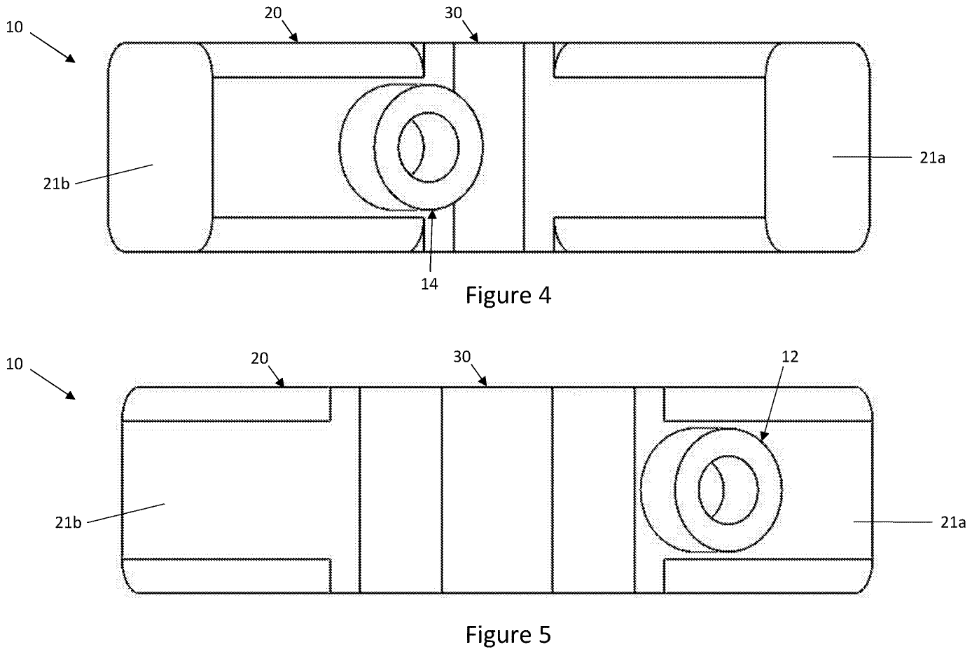

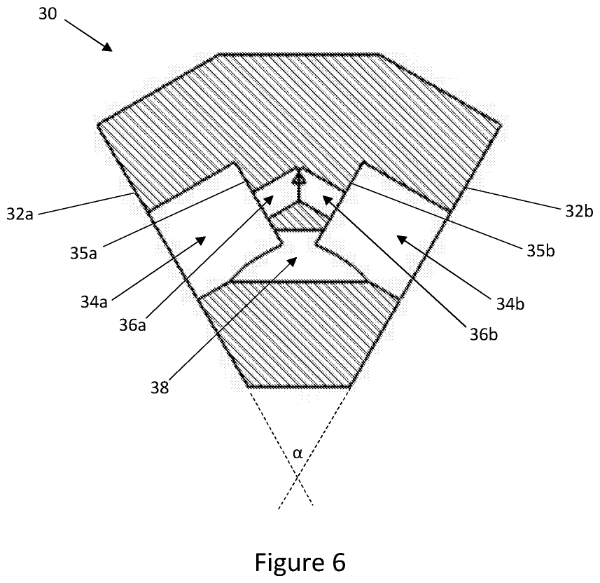

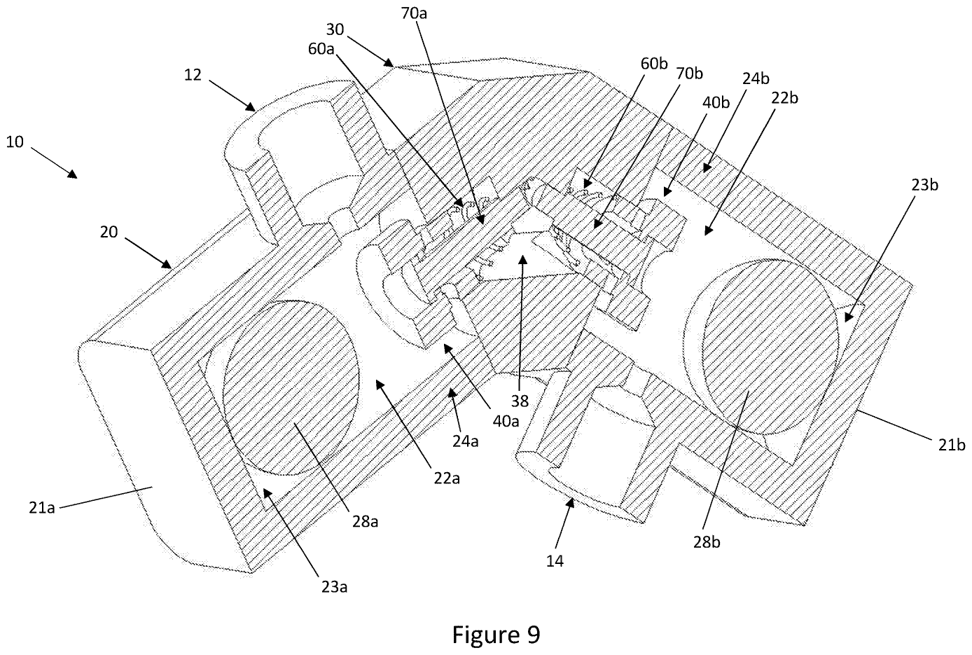

With reference to FIGS. 1 to 9, below is described a device 10 according to a first embodiment of the present invention. The device 10 comprises a body 20, a first valve assembly 40a and a second valve assembly 40b. The body 20 is formed of a first portion 21a, a second portion 21b and a joining portion 30 therebetween.

The first and second portions 21a, 21b have chambers 22a, 22b formed therein respectively. Each chamber 22a, 22b is formed as a cylindrical bore along a first axis 26a and a second axis 26b respectively, each chamber 22a, 22b with a closed end 23a, 23b and an open end 24a, 24b. An inlet 12 is formed in the first portion 21a, whilst an outlet is formed in the second portion 21b.

As seen in FIG. 6, the joining portion 30 has a first face 32a and a second face 32b at an angle a relative to each other. This angle a is 60°, however angles in the range of 0° to 90° are also envisaged. The first and second faces 32 a, 32 b have first and second openings 34a, 34b respectively, formed as cylindrical bores through the faces 32a, 32b. Each opening 34a, 34b has a base 35a, 35b and a recess 36a, 36b respectively. The recesses 36a, 36b are formed as smaller cylindrical bores through the base 35a, 35b of the respective opening 34a, 34b. A port 38 is arranged as a bore between the first and second openings 34a, 34b.

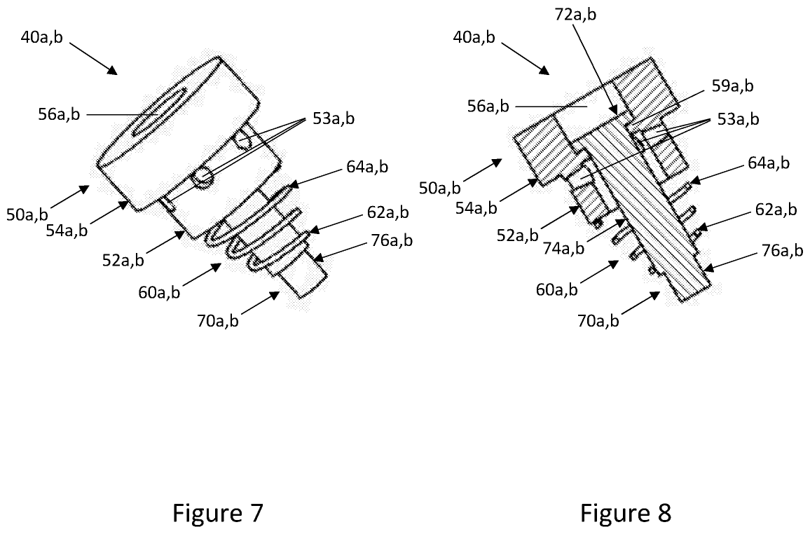

As seen in FIGS. 7 and 8, the first valve assembly 40a comprises a first valve member 50a, first spring 60a and first pin 70a.

The first valve member 50a has a shaft portion 52a and a head portion 54a. The shaft and head portions 52a, 54a are cylindrical and coaxial, with the head portion 54a having a larger diameter than that of the shaft portion 52a.

A cylindrical shaft bore 56a is disposed axially through the shaft portion 52a, whilst a cylindrical head bore 58a is disposed axially through the head portion 54a. The shaft bore 56a and the head bore 58a are coaxial, with the shaft bore 56a having a smaller diameter than that of the head bore 58a. The head bore 58a does not extend through the full length of the head portion 54a, such that ridge 59a is formed between the shaft bore 56a and the head bore 58a.

The shaft portion 52a has apertures 53a arranged therethrough and into the shaft bore 56a. The apertures 53a are arranged equidistantly around the shaft portion 52a proximate to the point where the shaft portion 52a meets the head portion 54a.

The first spring 60a is a conical spring, having a narrow end 62a and a wide end 64a. First and second pins 70a, 70b have cylindrical head portions 72a, 72b, shaft portions 74a, 74b and fixing portions 76a, 76b respectively. The head portions 72a, 72b have a greater diameter than that of the shaft portions 74a, 74b, which in turn have a greater diameter than that of the fixing portions 76a, 76b.

The second valve assembly 40 b comprises an equivalent second valve member 50b, second spring 60b and second pin 70b as described above in relation to the first valve assembly 40a.

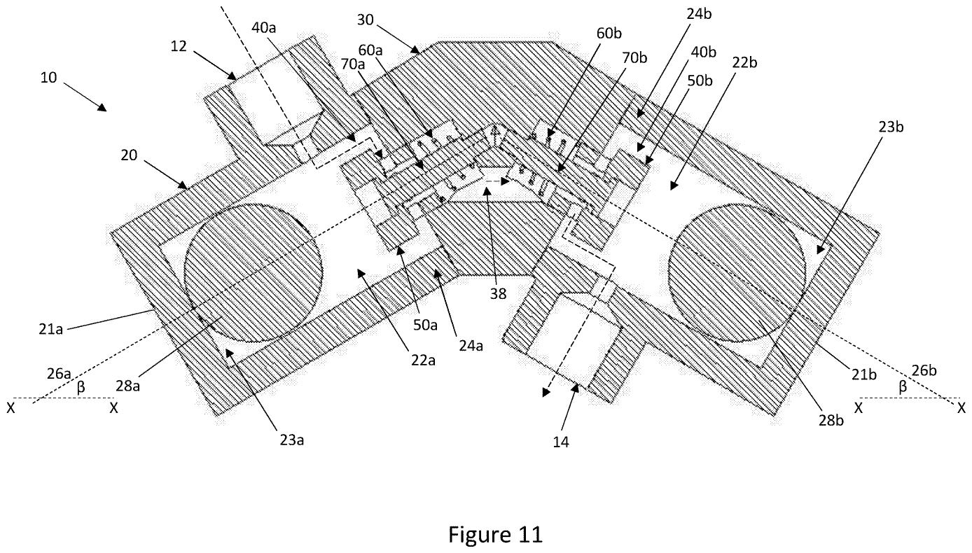

As seen in FIGS. 11 to 13, the first and second portions 21a, 21b are arranged such that the open ends 24a, 24b of the chambers 22a, 22b are connected to the first and second faces 32a, 32b of the joining portion 30 respectively. Thus, due to the angle a between the first and second faces 32a, 32b of the joining portion 30, the first and second axes 26a, 26b of the chambers 22a, 22b are arranged at an angle β relative to a horizontal axis X-X. This angle β is 30°, however angles in the range of 0° to 45° are also envisaged.

Chambers 22a, 22b are arranged such that the open ends 24a, 24b face each other and are in fluid communication with the respective first and second opening 34a, 34b of the joining portion 30. As such, the open ends 24a, 24b are fluidly connected by port 38. In this way, the first and second chambers 22a, 22b and the joining portion 30 are symmetrical in the body 20 about a plane perpendicular to the horizontal axis X-X. Furthermore, port 38 is parallel to the horizontal axis X-X.

Provided within each chamber 22a, 22b are first and second steel balls 28a, 28b. The balls 28a, 28b are made of stainless steel, however other materials such as brass and high carbon chromium steel are also envisaged. The balls 28a, 28b are sized such that they have a near identical diameter to that of the respective first and second chambers 22a, 22b. A tolerance of 0.10 mm is allowed, however tolerances in the range of 0.01 mm to 1.00 mm are also envisaged.

The inlet 12 is fluidly connected to the first chamber 22a and the outlet 14 is fluidly connected to the second chamber 22b.

The shaft portion 52a, 52b of each valve member 50a, 50b is arranged in the respective first and second opening 34a, 34b of the joining portion 30, such that the head portions 54a, 54b are located in the respective chamber 22a, 22b. A tolerance between the respective dimensions of the shaft portions 52a, 52b and openings 34a, 34b allow the valve members 50a, 50b to slide respective to the chambers 22a, 22b.

First and second springs 60a, 60b are also arranged in the respective first and second opening 34a, 34b of the joining portion 30, between the shaft portions 52a, 52b and the base 35a, 35b of the openings 34a, 34b. The wide end 64a, 64b of each spring 60a, 60b acts on the respective shaft portion 52a, 52b, whilst the narrow end 62a, 62b acts on the base 35a, 35b of the respective opening 34a, 34b.

First and second pins 70a, 70b are arranged through the respective bores 56a, 56b, 58a, 58b and springs 60a, 60b. The pins 70a, 70b are affixed by the fixing portions 76a, 76b in the respective first and second recess 36a, 36b.

The head portions 54a, 54b of the valve members 50a, 50b are sized such that they are larger than that of the respective opening 34a, 34b, so that the entire valve member 50a, 50b cannot enter the respective opening 34a, 34b. The head portions 72a, 72b of the pins 70a, 70b are sized such that the respective ridge 59a, 59b cannot pass over the head portion 72a, 72b. In this way, the sliding of the valve members 50a, 50b relative to the respective chambers 22a, 22b is controlled and limited.

As will now be described with reference to FIGS. 11 to 13, the device 10 prevents fluid transfer when undergoing extreme lateral accelerations in first and second directions 80a, 80b, both directions acting in the horizontal direction (i.e., along axis X-X).

FIG. 11 shows a passive state where there is no or little lateral acceleration in either of the first and second directions 80a, 80b. Both balls 28a, 28b remain in the closed ends 23a, 23b of the respective chambers 22a, 22b due to gravity acting upon the ball 28a, 28b to pull them to the bottom of the sloped chambers 22a, 22b. As such, the force provided by the springs 60a, 60b acting on the shaft portions 52a, 52b of the valve members 50a, 50b is only resisted by contact between the head portions 72a, 72b of the pins 70a, 70b and the ridges 59a, 59b of the valve members 50a, 50b.

As a result, the apertures 53a, 53b are open and thus fluid can flow through the device 10 from the inlet 12 to the outlet 14 (as shown by the dashed arrows in FIG. 11). In this state, braking acts as normal, as fluid can travel from the fluid reservoir 16 into the master cylinder 18 and vice versa.

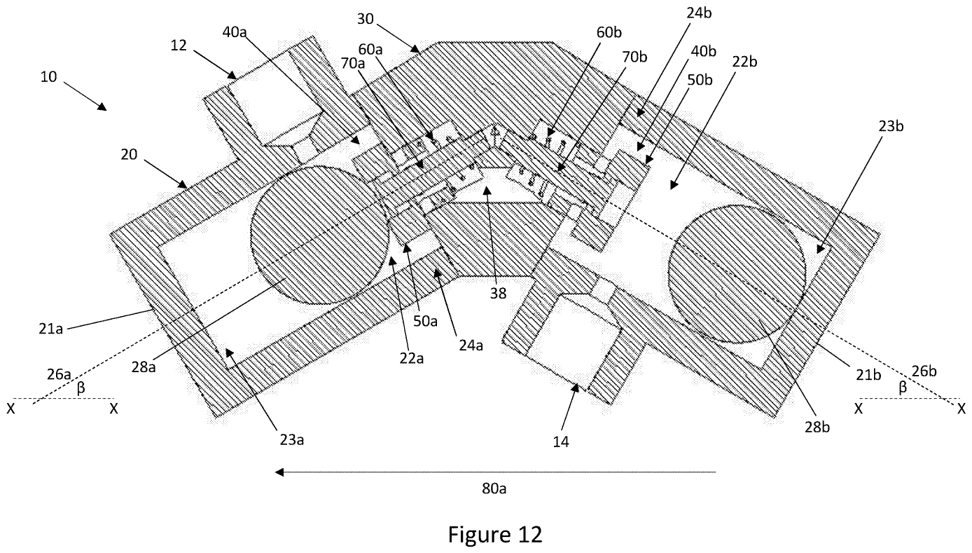

FIG. 12 shows a first state where the device 10 experiences lateral acceleration in the first direction 80a. The force of the acceleration causes the first ball 28a to move in the first chamber 22a to contact the head portion 54a of the first valve member 50a. The head bore 58a is sized such that the curvature of ball 28a fits perfectly within said bore 58a, providing a good and even contact for force to be exerted upon the valve member 50a.

The force on the ball 28a exerted due to the lateral acceleration in the first direction 80a acts against gravity along the inclined slope of the first chamber 22a, the force provided by the first spring 60a and the force provided against the valve member 50a by movement of the fluid. When this force is sufficient, i.e., the lateral acceleration is sufficient, the first valve member 50a moves with the ball 28a, pushing the shaft portion 52a further into the opening 34a. The movement is limited by the contact between the head portion 54a of the valve member 50a and the first face 32a of joining portion 30. The shaft portion 52a being further into the opening 34a blocks the apertures 53a. This prevents fluid from flowing through the device 10 and thus from flowing between the reservoir 16 and the master cylinder 18. This in turn prevents fluid from returning from the master cylinder to the reservoir and thus prevents the knockback condition.

After the lateral acceleration has decreased and therefore the force on the first valve member 50a by the first ball 28a has decreased, the valve member 50 returns to its passive state position (as in FIG. 11). Thus, the apertures 53a are no longer blocked and fluid can once again flow through the device 10.

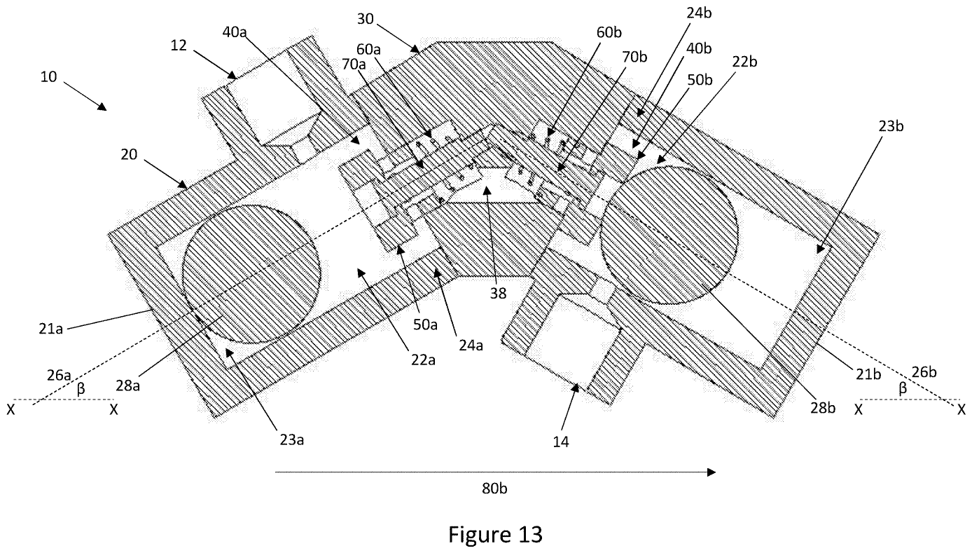

FIG. 13 shows a second state where the device 10 experiences lateral acceleration in the second direction 80b. The same process as described above occurs, but with the second ball 28b acting on the second valve member 50b instead, causing the apertures 53b in the second valve assembly 30b to close. As such, the control afforded by device 10 is bilateral.

In this way, fluid flow can be prevented in conditions with high lateral acceleration passively, i.e., without needing to actively control the device 10.

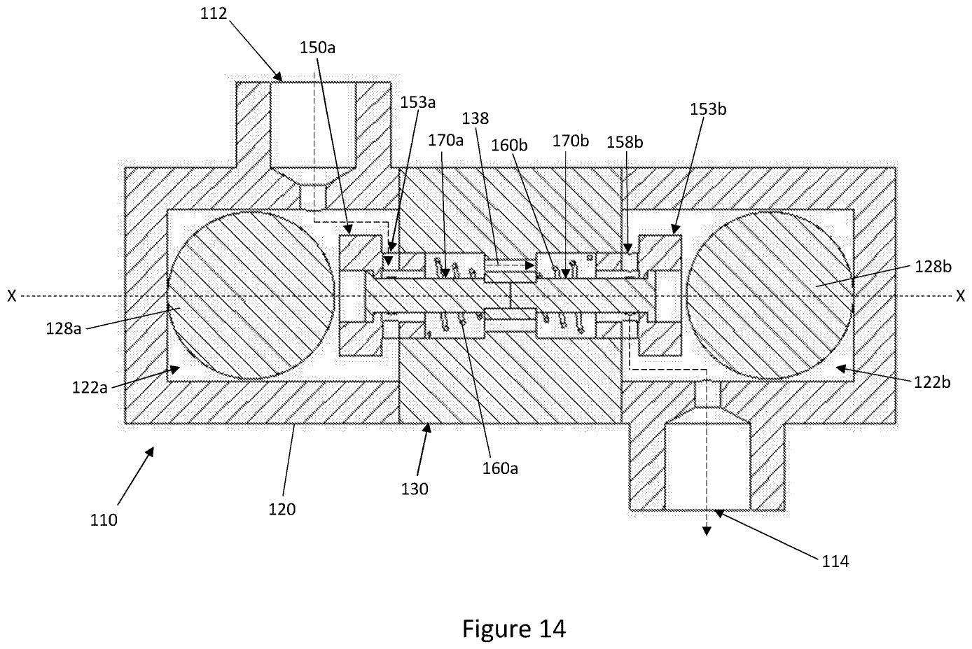

With reference to FIGS. 14 to 16, below is described a device 110 according to a second embodiment of the present invention. The device 110 comprises the same components as the device 10 of the first embodiment, with the exception that the two opposing faces of joining portion 130 are not arranged at an angle. As such, the chambers 122a, 122b are arranged parallel along the horizontal axis X-X. In this way, the lateral acceleration of the device 110 is sufficient for it to function as described in relation to the first embodiment.

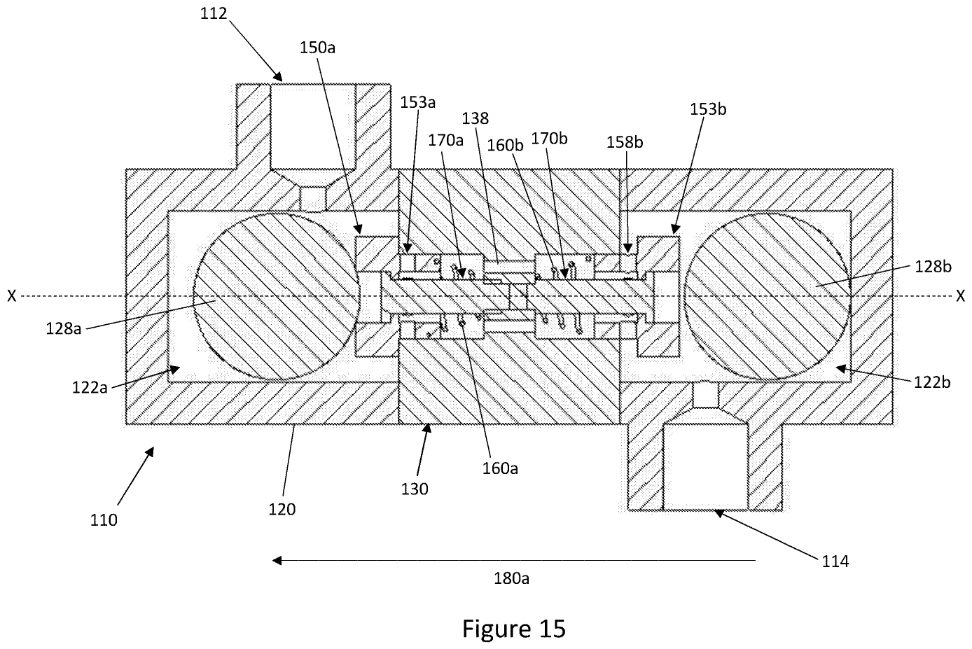

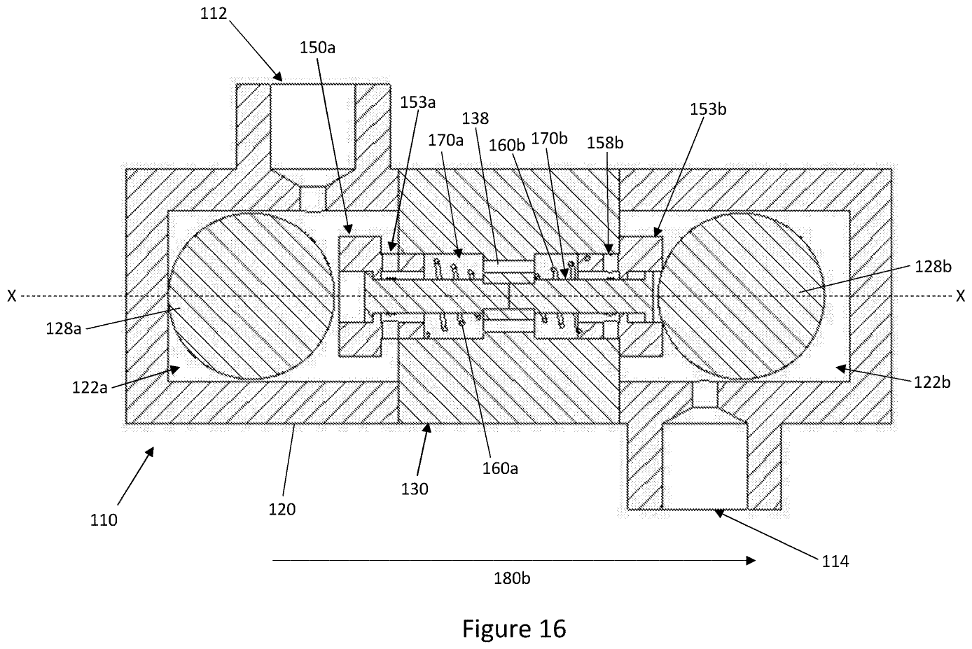

As seen in FIG. 14, the device 110 has a neutral position in which the apertures 153a, 153b are open and thus fluid can flow through the device 110 from the inlet 112 to the outlet 114 (as shown by the dashed arrows). FIG. 15 shows a first state where the device 110 experiences lateral acceleration in a first direction 180a causing aperture 153a to be closed to fluid flow. FIG. 16 shows a second state where the device 110 experiences lateral acceleration in a second direction 180b causing aperture 153b to be closed to fluid flow.

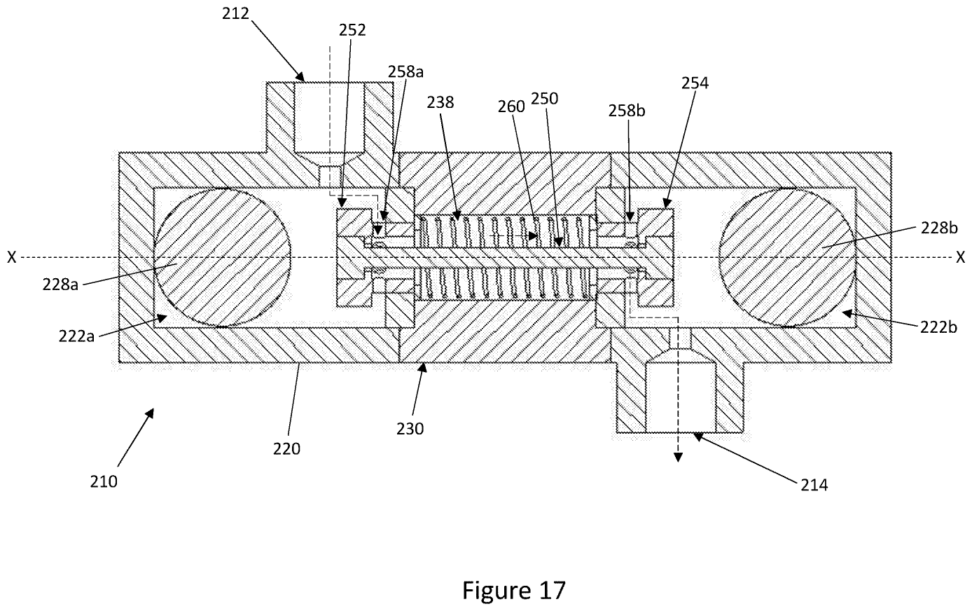

With reference to FIGS. 17 to 19, below is described a device 210 according to a third embodiment of the present invention. The device 210 comprises a body 220 with a first chamber 222a and a second chamber 222b separated by a central portion 230 through which a passage 238 extends. The first chamber 222a has an inlet 212, whilst the second chamber 222b has an outlet 214.

The device 210 further comprises a first steel ball 228a, a second steel ball 228b, a spring 260 and a shuttle 250. As with the first and second embodiments, other inertia masses are useable in place of the steel balls 228a, 228b. The shuttle 250 has a first end 252 and an opposite second end 254, with apertures 258a, 258b extending through the first and second ends 252, 254 of shuttle 250 respectively.

The shuttle 250 is located, and is slidable in, the passage 238 of the body 220. The first steel ball 228a is located in the first chamber 222a, whilst the second steel ball 228b is located in the second chamber 222b. The first steel ball 228a is operably connected to the first end 252 of the shuttle 250, whilst the second steel ball 228b is operably connected to the second end 254.

The spring 260 is located within the passage 238 and contacts both ends 252, 254 of the shuttle 250 such that the shuttle 250 is still slidable within the passage 238, and allowing fluid to travel from the first chamber 222a to the second chamber 222b (or vice versa) via the passage 238 and the apertures 258a, 258b.

As seen in FIG. 17, the device 210 has a neutral position in which the shuttle 250 is roughly central within the passage 238. In this passive state of FIG. 17, fluid can travel through inlet 212 into the first chamber 222a, then into the passage 238 via the first aperture 258a, through the passage 238 and out of the second aperture 258b into the second chamber 222b, and then finally out of outlet 214 (as shown by the dashed arrows). Fluid can also flow from the outlet 214 to the inlet 212 in the opposition direction.

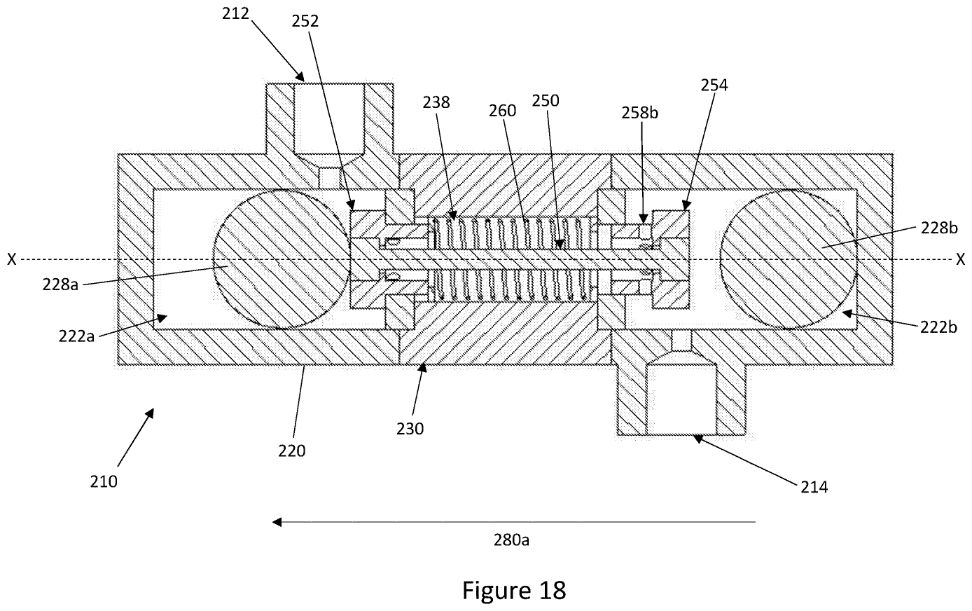

FIG. 18 shows a first state where the device 210 experiences lateral acceleration in a first direction 280a. The force of the acceleration causes the first steel ball 228a to act on the first end 252 of the shuttle 250.

The force on the first steel ball 228a exerted due to the lateral acceleration in the first direction 280a acts against the force provided by the compression of the spring 260, as seen in FIG. 18. When this force is sufficient, i.e., the lateral acceleration is sufficient, the shuttle 250 moves with the first steel ball 228a, pushing the shuttle 250 further into the passage 238 in an opposite direction to the first direction 280a. This movement of the shuttle 250 causes the first aperture 258b to be blocked by the wall of the passage 238. This prevents fluid from flowing through the passage 238 and thus the device 210. As with the first and second embodiments, this prevents fluid from returning from the master cylinder to the reservoir and thus prevents the knockback condition.

After the lateral acceleration has decreased and therefore the force on the shuttle 250 by the first steel ball 228a has decreased, the shuttle 250 returns to its passive state position (as in FIG. 17) due to the elastic potential energy stored in the compressed spring 260. Thus, the first aperture 258a is no longer blocked and fluid can once again flow through the device 210.

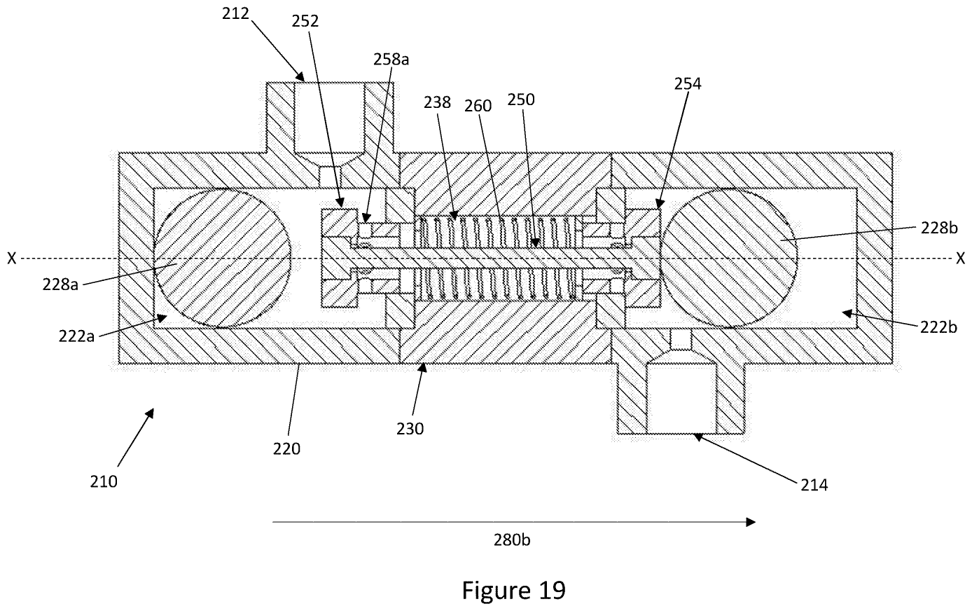

FIG. 19 shows a second state where the device 210 experiences lateral acceleration in a second direction 280b. The same process as described above occurs, but with the second steel ball 228b acting on the second end 254 of the shuttle 250 instead, causing the second aperture 258b of the channel 256 to be blocked. As such, the control afforded by device 210 is bilateral.

Alternative inertia masses to the balls 28a, 28b, 128a, 128b, 228a, 228b may be used. For example, they may be formed as part of the respective valve member 50a, 50b, 150a, 150b or ends 252, 254 of shuttle 250. In this arrangement, it is the inertia of the valve member 50a, 50b, 150a, 150b or shuttle 250 that provides the function as described above in relation to the opening and closing of the device.

The force acting upon any of the valve members 50a, 50b, 150a, 150b or ends 252, 254 of shuttle 250 may instead or additionally be provided by an electromagnetic system. In this example, the valve member 50a, 50b, 150a, 150b or shuttle 250 acts as a movable armature located within coils of the electromagnet, such that the electromagnetic field generated by the coil provides the force on the valve member 50a, 50b, 150a, 150b or shuttle 250 towards the first (steady/open) state of the device.

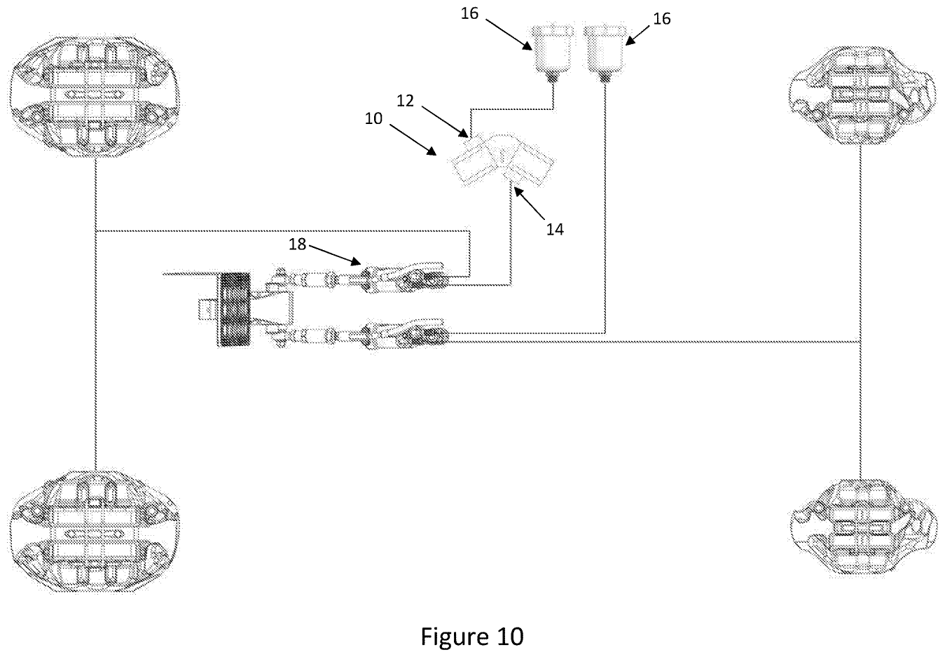

As seen in FIG. 10, the inlet 12 of the device 10 is fluidly connected to a fluid reservoir 16, whilst the outlet 14 of the device 10 is fluidly connected to a master cylinder 18. This could alternatively be the devices 110, 210 of the second and third embodiments, connected via the inlet 112, 212 and outlet 114, 214 respectively. Placing a valve like the device 10, 110, 210 between the fluid reservoir 16 and master cylinder 18 would not normally be contemplated, as this would restrict the rate the fluid can flow through the system. However, the above and below described benefits have been found to be worth this flow rate reduction.

As described above in relation to the operation of the three embodiments, when the device 10, 110, 210 experiences lateral acceleration, said device 10, 110, 210 transitions to a closed state in which fluid is not able to flow through it from the fluid reservoir 16 to the master cylinder 18, and vice versa. This reduces the amount of fluid able to move through the system, reducing the knockback effect.

However, in this closed state fluid is still able to flow from the outlet 14, 114, 214 of the device 10, 110, 210 into the master cylinder 18, and vice versa. To compensate for this, the connection between the outlet 14, 114, 214 of the device 10, 110, 210 and the master cylinder 18 is via a collapsible hose. The fluid requirement whilst the device 10, 110, 210 is closed is served by the reduction in internal volume of said collapsible hose, thus allowing for volume compensation from the draw of the master cylinder 18.

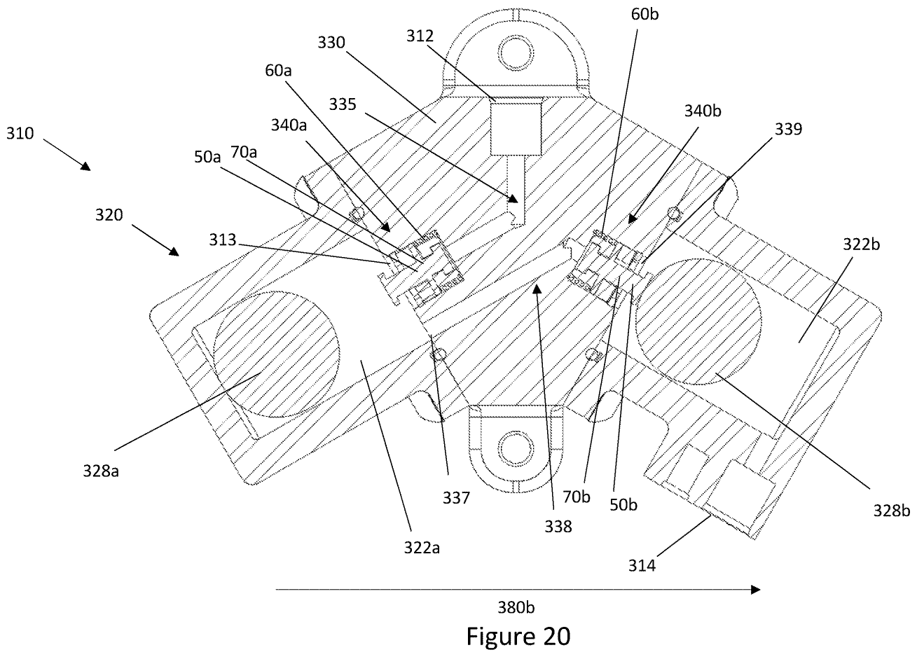

With reference to FIG. 20, there is described a device 310 according to a fourth embodiment of the present invention. The device of the fourth embodiment shares a number of common features with that of the first embodiment 10. Corresponding parts bear the same reference numerals but preceded by a “3”. The device 310 comprises a body 320 with a first chamber 322a and a second chamber 322b separated by a central portion 330. The device 310 further comprises a first ball 328a, a second ball 328b (the inertia masses). As with the first, second and third embodiments, other inertia masses are useable in place of the balls 328a, 328b, for example cylindrical bearings or blocks. The inertia masses of the embodiment depicted in FIG. 20 may be any inertia mass as previously described. The balls are preferably made of steel but may be made of other materials, e.g. an aluminium alloy, an iron alloy, or any other suitable alloy.

The central portion 330 has an inlet 312, a first chamber inlet 313 and a passageway 335. The passageway 334 fluidly connects the first chamber inlet 313 to the device inlet 312 and first chamber inlet 313. The passageway 335 extends through the central portion 330. Disposed at the first chamber inlet 313 is a first valve assembly 340a. The first valve assembly 340a is disposed at the end of passageway 335 and closing the first valve assembly 340a prevents movement of fluid into chamber 322a from passageway 335 or into passageway 335 from chamber 322a. The first valve assembly 340a may be any valve assembly of a previous embodiment (e.g. 40a). The first valve assembly 340a comprises a first valve member 50a, first spring 60a and first pin 70a.

The central portion 330 has a first chamber outlet 337, a second chamber inlet 339 and a central passage 338 extending therebetween to fluidly connect the outlet 337 and inlet 339. The central passageway 338 fluidly connects the first chamber outlet 317 (and therefore the first chamber 322a) to the second chamber inlet 339. The passageway 338 extends through the central portion 330 as shown in FIG. 20. Disposed at the second chamber inlet 339 is a second valve assembly 340b. The second valve assembly 340b is disposed at the end of passageway 338 and closing the second valve assembly 340b prevents movement of fluid into chamber 322b from passageway 338 or into passageway 338 from chamber 322b. Closing the second valve assembly 340b therefore disrupts fluid communication between the first and second chambers 322a, 322b. The second valve assembly 340b may be any valve assembly of a previous embodiment (e.g. 40a, 40b). The second valve assembly 340b comprises a second valve member 50b, first spring 60b and first pin 70b.

As can be seen from FIG. 20 there is no valve assembly disposed in the first chamber outlet 337. This enables the first chamber 322a to remain connected to the second chamber 332b even when the first ball 328a acts upon the first valve assembly 340a to close it (similar to the case in the embodiment shown in FIG. 12). In this case, both chambers 322a and 322b are available for the supply of fluid.

As will be apparent, FIG. 20 shows a second state where the device 310 experiences lateral acceleration in a second direction 380b. The direction 380b is indicated by arrow 380b and is to the right-hand-side of FIG. 20. As will be apparent when considering the previously described embodiments, when the device 310 experiences lateral acceleration in the second direction 380b the second valve assembly 340b is closed as the ball 328b acts upon the second valve assembly 340b. This disconnects outlet 314 from the inlet 312. Likewise, where the lateral acceleration is in the opposite direction (to the left-hand side of the FIG. 20) it will be apparent to the skilled reader that the ball 328a will act upon the first valve assembly 340a to close the first valve assembly 340a and the second ball 328b will not act upon the second valve assembly 340b such that the second valve assembly 340b is open.

### The First Control System 1200

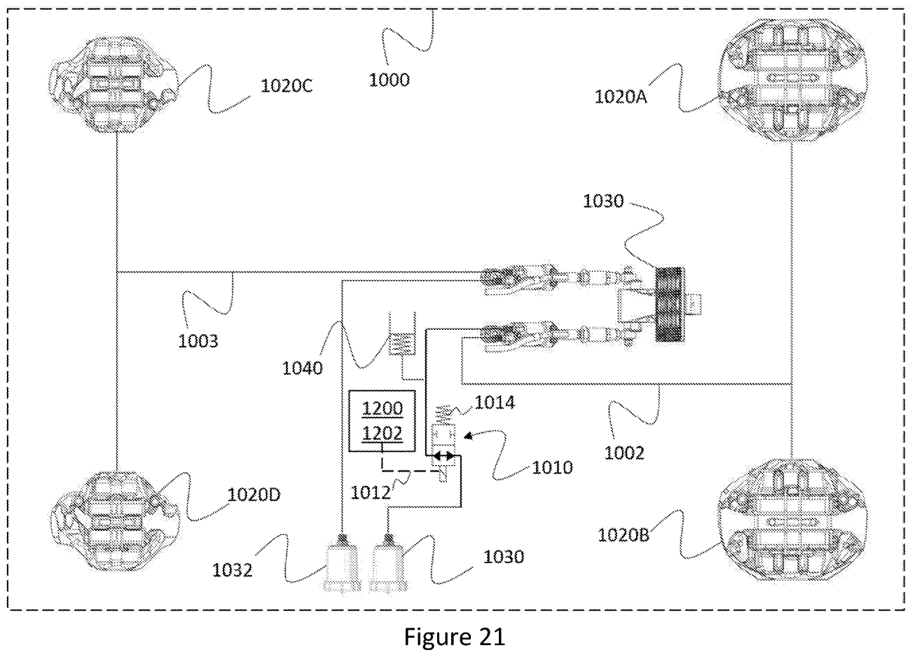

With reference to FIGS. 21 to 24 a control system 1200 for controlling a brake system 1000 of a vehicle is described. The brake system 1000 is represented by dashed lines 1000 in FIG. 21. The brake system 1000 is a sub-system of the vehicle. The vehicle, and other components thereof have been omitted for reasons of clarity. The brake system 1000 depicted in FIG. 21 has a brake circuit 1002. The brake circuit 1002 comprises a brake fluid reservoir 1030, at least one hydraulically actuated brake 1020A, 1020B, 1020C, 1020D (1020A-D denoting all four for brevity) and an electromechanical valve 1010. As shown in FIG. 21, the hydraulically actuated brakes 1020A-D are brake calipers. As will be apparent from careful review of FIG. 21, there are two different types of calipers depicted (a first set of 1020A and 1020B, and the second set of 1020C and 1020D). As will be apparent to the skilled reader, the depicted implementation is for teaching the invention and the hydraulically actuated brakes may be of any type, e.g. either of the first set or second set or an alternative design. As will be clear from careful review of FIG. 21 the vehicle depicted has four wheels (and therefore four brake calipers) and therefore may be a car, van or other four-wheeled vehicle. This depiction is not intended to be limiting and the invention may be employed on other vehicles with alternative number of wheels, for example a bicycle, a motorbike, a tricycle, a three-wheel car, a six-wheeled vehicle, a truck, a lorry, a heavy goods vehicle, etc. Optionally, the vehicle may be any one of a car, motorcycle, sport car, rally car, supercar, hypercar, coupé, Sports Utility Vehicle (SUV), an open-wheel single-seater formula racing car.

The brake calipers 1020A and 1020B are shown fluidly connected to the electromechanical valve 1010 and brake fluid reservoir 1030 by one or more fluid lines between these components as shown in FIG. 21.

The depicted embodiment also comprises a user operated pedal 1030. The pedal 1030 shown in the FIG. 21 is configured to hydraulically actuate the brake calipers 1020A-D (via the first and second brake fluid circuits 1002 and 1003). In alternative configurations where the pedal 1030 is an electrical brake which does not hydraulically control the brakes but instead is a so-called brake-by-wire configuration, the pedal 1030 and a controller of a brake-by-wire system are configured to cause the hydraulic actuation of the brake calipers 1020A-D as is known in the art, for example by causing a piston to apply hydraulic pressure on the brake circuit causing the brake calipers 1020A—D to engage a brake pad.

The brake system 1000 may additionally comprise a volume compliance chamber 1040. The volume compliance chamber 1040 is fluidly connected to the hydraulically actuated brake(s) 1020A-D and is configured to maintain fluid pressure and/or brake fluid volume within the brake system 1000 when the electromechanical valve 1010 is closed during a lateral acceleration event. The volume compliance chamber 1040 may be a spring biased piston, the spring biased piston configured to a closed position such that brake fluid is forced out of the volume compliance chamber 1040 through an aperture when there is a pressure drop in the brake circuit 1002 for example when the electromechanical valve 1010 is closed. When the balance fluid is no longer required the action of the brake fluid may push against the spring of the piston increasing the volume in the piston chamber such that pressure may be maintained in the system. Alternatively, the volume compliance chamber 1040 may be a flexible walled chamber, the flexible walled chamber having an aperture connected to the brake circuit 1002. When a pressure drop occurs in the brake circuit 1002 fluid may be pulled out of the flexible walled chamber without an air gap forming or with a minimal air gap forming to maintain fluid level in the system.

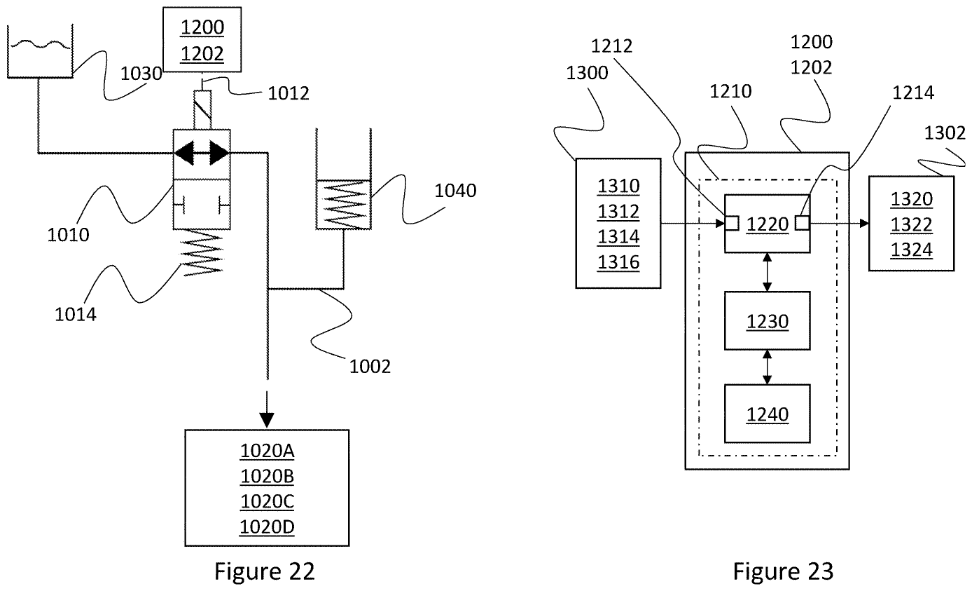

As shown in FIGS. 21 and 22, the volume compliance chamber is located downstream of the electromechanical valve 1010 and upstream of the brake calipers 1020A-D.

In alternative configurations, brake calipers 1020C and 1020D may also be connected fluidly to the electromechanical valve 1010 and be part of the first brake fluid circuit 1002.

In alternative configurations, there may be a second brake circuit 1003 identical or similar to the first brake circuit but connected to only the second set of brake calipers 1020C and 1020D. The second brake fluid circuit 1003 having a second electromechanical valve and a second brake fluid reservoir 1032 and optionally a second volume compliance chamber. In such a configuration there may be no fluid communication between the first brake fluid circuit 1002 and the second brake fluid circuit.

In alternative configurations the second brake circuit 1003 does not have an electromechanical valve 1010 as depicted in the embodiment of FIG. 21. In this example, the second brake circuit 1003 has a second brake fluid reservoir 1032.

The control system 1200 will now be described in more detail with the aid of FIGS. 21 to 25, the control system 1200 is configured to operate an electromechanical valve 1010 in dependence upon one or more input parameters and control system logic as will be discussed below.

The controller system 1200 comprises one or more processors 1210, represented by dot-dashed line 1210 in FIG. 23. The processor(s) 1210 comprise an input means 1212 and an output means 1214.

The input means 1212 is arranged to receive one or more input signals 1300, such as the acceleration signal 1310, a valve position signal 1312, a driver input signal 1314, and a vehicle parameter signal 1316.

The output means 1214 is arranged to output one or more output signals 1302, such as the valve signal 1320, a delay signal 1322 and an override signal 1324.

The input and output means 1212, 1214 may be any input/output means as known in the art suitable for the purpose of input and/or output of a signal. For example, the input and/or output means may be a data bus connector.

The processor(s) 1210 comprise an interface 1220, a processing means 1230 and a memory 1240. The interface 1220 comprises the input and output means 1212, 1214. The interface 1220 is electrically connected to the processing means 1230 to enable two-way communication of data between the interface 1220 and the processing means 1230. The processing means 1230 is electrically connected to the memory means 1240 to enable one or two-way communication between the memory means 1240 and the processing means 1230. Two-way communication is indicated by the two-headed arrows in FIG. 23 between the interface 1220 and the processing means 1230 for example. One way communication is indicated by a single-headed arrow, for example between the inputs 1300 and the input means 1212 and between the output means 1214 and the outputs 1302.

The memory means 1240 may be a read only memory or a read-writable memory. Where the memory means 1240 is a read-writable memory the processor 1230 may configured to write data, such as data relating to a sensed lateral acceleration from a sensor to the memory means 1240.

The memory means 1240 comprises instructions that when executed by a computer (the controller 1210) cause the controller to carry out a method as will be described in more detail below.

The control system 1200 is shown in FIGS. 21 and 22 as part of the brake system 1000. The control system 1200 is configured to control the electromechanical valve 1010. This control is achieved via a connection 1012 shown as dashed line 1012 between the electromechanical valve 1010 and the control system 1200.

The connection 1012 is configured to enable one-way or two-way communication between the control system 1200 and the electromechanical valve 1010. The electromechanical valve 1010 may have a controller (not shown) or may be controlled by the controller 1210 of the control system 1200.

The electromechanical valve 1010 in the depicted embodiment of FIGS. 21 and 22 is a two-position two-way valve (a 2/2 valve 1010). The 2/2 valve 1010 is biased by a biasing means 1014. The biasing means 1014 biases the electromechanical valve 1010 into the open position (as shown in FIGS. 21 and 22) to enable fluid flow through the electromechanical valve 1010.

Whilst an electromechanical valve 1010 is depicted in the FIGS. 21 and 22 it is envisioned that alternative valves may be employed. Preferably the electromechanical valve 1010 is a solenoid valve. Alternatively, for example, a vacuum driven valve or a pneumatic valve rather than an electromechanical valve 1010 may be utilised without departing from the scope of the invention. Where a vacuum driven valve or pneumatic valve is employed the valve may be of similar configuration as the electromechanical valve 1010 (e.g. a 2/2 valve) other than that the actuation of the valve is controlled by a vacuum or compressed gas source. The compressed gas source may be a source of clean dry air. The vacuum driven valve or pneumatic valve may be controlled by a pilot valve the pilot valve may in-turn be controllable by the control system.

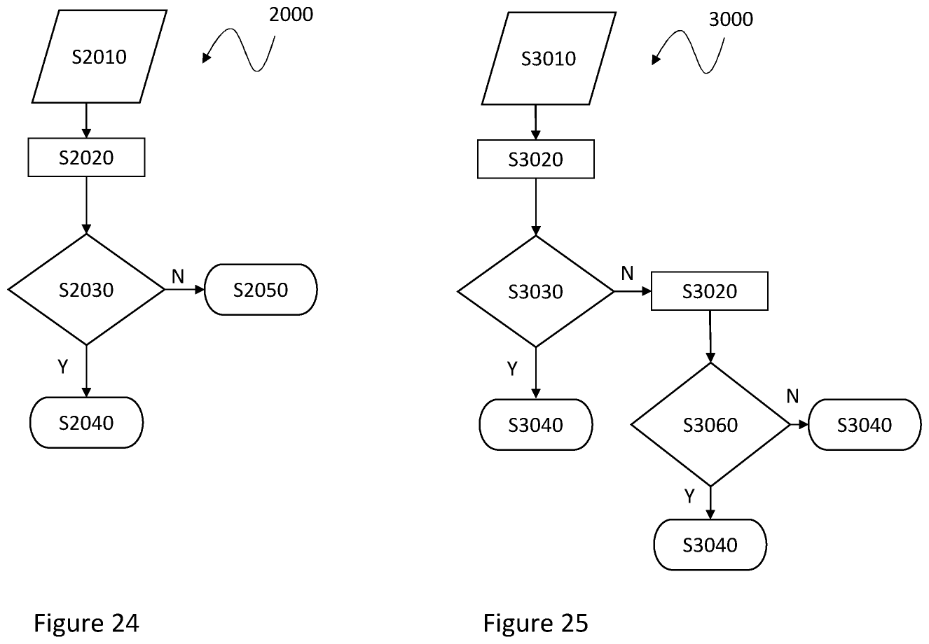

The logic undertaken by control system 1200 will now be described with the aid of flow chart 2000 shown in FIG. 24. The flow chart 2000 describes a number of steps employed by the control system to determine whether to close the electromechanical valve 1010 where a lateral acceleration of the vehicle is greater than a predetermined value.

At step S2010 the control system 1200 receives an acceleration signal 1310 comprising information indicative of a vehicle lateral acceleration. The vehicle lateral acceleration may be sensed by one or more acceleration sensors located on or in the vehicle. The sensors may be any one of or a combination of capacitive MEMS (Micro-Electro-Mechanical Systems), Piezoresistive, or Piezoelectric accelerometers, or other sensor known in the art suitable for the purpose of sensing acceleration.

Alternatively, the control system 1200 determines the lateral acceleration signal 1310 in dependence upon the sensed information from the one or more acceleration sensors located on or in the vehicle.

Next at step S2020 the control system 1200 determines whether the previously determined or received vehicle lateral acceleration from the acceleration signal is at or exceeds a predetermined threshold value. The predetermined threshold value may be between 3 to 15 ms² . Preferably, the predetermined threshold value may be between 4 to 10 ms². More preferably, the predetermined threshold value may be 7 ms². The predetermined threshold value may be stored within a memory means 1240 accessible to the control system 1200.

After the determination step S2020 the flow chart 2000 moves to step S2030. Step S2030 is a decision step with two branches a ‘Y’ branch which moves the control system logic to step S2040 if the control system 1200 has determined that the vehicle lateral acceleration equals or is greater than the predetermined threshold value, and a ‘N’ branch which moves the control system logic to step S2050 where the vehicle lateral acceleration is determined to be less than the predetermined threshold value.

At step 2050 the flow chart terminates.

At step 2040 the control system 1200 outputs the one or more output signals 1302 including the valve signal 1320. The valve signal 1320 requests that the electromechanical valve 1010 is to be closed. After the control system 1200 outputs the output signal 1302 the logic terminates.

Optionally, instead of terminating the logic at step 2040 the control system may continue to determine whether the lateral acceleration is at or exceeds the predetermined threshold value. Should the lateral acceleration decrease below the predetermined threshold value the valve signal 1320 is configured to request the electromechanical valve 1010 to open. This step may involve the control system 1200 re-outputting an updated valve signal 1320 to request the valve 1010 to open.

The control system 1200 may re-undertake the logic of flow chart 2000 every time an acceleration event is sensed by a sensor or an acceleration signal 1310 is received by the control system 1200.

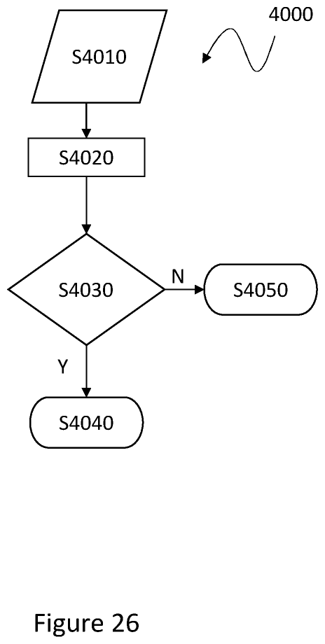

An optional flow chart 3000 will now be described with the aid of FIG. 25. The flow chart 3000 shares a number of common features with flow chart 2000 as such the same or similar steps will be renumbered in the 3000s but will not be described in detail. The flow chart 3000 advantageously may reduce the likelihood of any hydraulic hammering by requesting the valve remain closed for a period of time. Such a system may be advantageous where a vehicle is traversing a number of turns, such as a chicane, resulting in lateral acceleration acting on the vehicle in a (for example) left-right-left sequence.

At step S3010 in addition to the previously described inputs there the control system also receives or determines a valve position signal 1312 indicative of the position of the electromechanical valve 1010.

In flow chart 3000 after S3030 and the ‘N’ branch from S3030, the flow chart 3000 moves to a determination step S3020. At step S3020 the control system determines the current state of the valve 1010 and whether it is in an open or closed configuration. This determination is made in dependence upon the valve position signal.

Subsequently the flow chart 3000 moves to decision step S3060. At decision step S3060 the control system 1200 is configured to move down two branches, the ‘Y’ branch to step S3040 where it is determined that the valve is currently closed. At S3040 the control system 1200 is configured to output a delay signal 1322 to delay actuation of the electromechanical valve until the end of the delay. The delay signal is configured to delay actuation of the electromechanical valve by at least 0.5 seconds to 10 seconds, preferably by at least 2 seconds, further preferably by at least 1 second. As a result, this can allow the reduction of any residual pressure in the system to dissipate after a lateral acceleration event and reduce the likelihood of any hydraulic hammering on the brake system.

From S3060 to step S3040 following the ‘N’ branch the logic of flow chart 3000 terminates as the valve is already in an open position.

Optionally, according to flow chart 3000 additional inputs may be received at S3010 and step S3040 may be modified. This additional input comprises receiving a driver input signal 1314 comprising information indicative of a driver brake request. In such an embodiment the delay signal 1322 may be configured to delay actuation of the electromechanical valve to open the valve until such a driver brake request is no longer received and/or until the maximum duration of the delay signal is reached, whichever occurs first.

Optionally, any of the previously described flow charts 2000, 3000 may determine or receive additional inputs as part of the vehicle parameter signal such as a brake request, steering angle, vehicle roll angle, GPS data (Global Positioning System), vehicle speed, and suspension height.

GPS is intended to cover other forms of global positioning data obtained from a satellite to provide autonomous geo-positioning. Such satellite navigation data, may for example be from GPS, GLONASS, BDS, Galileo or other global navigation satellite system (GNSS). The control system 1200 may be configured to receive GPS data from a satellite navigation device connected to, or part of, the control system 1200.

In such an embodiment, the control system may determine, based on the information contained within the vehicle parameter signal 1300, whether a lateral acceleration event has begun or whether a lateral acceleration event is likely to begin. This may be advantageous as the control system can anticipate likely lateral acceleration events.

As a result of this determination, the valve may make a number of subsequent optional steps:
output the valve signal based on a determination that a lateral acceleration event has begun; or
output the valve signal based on a determination that a lateral acceleration event is likely to begin; or
output, based on a determination that a lateral acceleration event has not begun, an override signal 1324 for opening the electromechanical valve; and/or
do not output the valve signal based on a determination that a lateral acceleration event has not begun.

The control system 1200 may also not output the valve signal based on a determination that a lateral acceleration event is not likely to begin.

The override signal 1324 and not outputting the output signal may occur together.

By utilising a number of different input parameters, the control system 1200 may determine whether the lateral acceleration event is already occurring or one is likely to occur soon. Such a control system 1200 may therefore be more reactive to upcoming situations. Likewise, by the control system 1200 preventing activation of the electromechanical valve 1010 it can prevent unwanted actuation of the valve 1010 where it may not be wanted by the user of the vehicle.

Where the vehicle parameter signal indicates that the driver or other control system has requested a brake to be applied (for example using pedal 1030) the control system 1200 may determine that a lateral acceleration event has already begun or is likely to begin shortly. This is because a braking event may often precede a lateral acceleration event for example when slowing to enter a corner.

A lateral acceleration event may be determined not to have begun or unlikely to begin shortly where the vehicle speed is 0 kph, or where the vehicle is located in an area, such as a maintenance area (e.g. a pit lane or garage) where vehicle maintenance is to be undertaken such as brake bleeding. As such it can be preferable to maintain the valve 1010 in an open position to permit brake bleeding.

A method is described to control a brake system 1000 of a vehicle according to the invention. In particular, the method is configured to undertake the steps of any of the described flow charts 2000, 3000 or optional embodiments of the control systems 1200 described here.

The method may be performed by the control system 1200 depicted in FIGS. 21-23. The memory 1240 may comprise computer-readable instructions, which, when executed by a computer or the control system 1200 or processor(s) 1210 or processing means 1230 perform the method in accordance with an embodiment of the invention.

### The Second Control System 1202

A second control system will now be described with the aid of FIGS. 21 to 26. The second control system 1202 shares a number of common features as control system 1200 and brake system 1000 depicted in FIGS. 21 to 23, as such common features will be referred to by the same numbers. FIGS. 21, 22 and 23 show the second control system 1202 as an alternative to the first control system 1200.

The second control system 1202 may differs from the first control system 1200 by the logic undertaken by said second control system 1202. However, the second control system 1202 may optionally also undertake the logic of the first control system 1200.

The logic of the second control system 1202 will be described with the aid of FIGS. 26 and 27 and flow charts 4000.

The flow chart 4000 describes a number of steps employed by the second control system 1202 to determine whether to close the electromechanical valve 1010 where a lateral acceleration event is determined to have begun or where it is determined one is likely to start.

At step S4010 the control system 1200 receives a vehicle parameter signal comprising information indicative of one or more of: a brake request, steering angle, vehicle roll angle, GPS data, vehicle speed, vehicle lateral acceleration and suspension height. The information may be sensed by one or more sensors as is known in the art of acceleration sensors located on or in the vehicle. The sensors may be any one of or a combination of capacitive MEMS (Micro-Electro-Mechanical Systems), Piezoresistive, or Piezoelectric accelerometers, or other sensor known in the art suitable for the purpose of sensing acceleration.

Alternatively, the control system 1202 determines the vehicle parameter signal comprising information indicative of one or more of: a brake request, steering angle, vehicle roll angle, GPS data, vehicle speed, vehicle lateral acceleration and suspension height, in dependence upon the sensed information from the one or more sensors located on or in the vehicle.

Next at step S4020 the control system 1202 determines whether a lateral acceleration event has begun or is likely to begin shortly. Where the vehicle parameter signal indicates that the driver has requested a brake the control system 1202 determines that a lateral acceleration event has already begun or is likely to begin shortly. This is because a braking event may often precede a lateral acceleration event for example when slowing to enter a corner.

A lateral acceleration event may be determined not to have begun or unlikely to begin shortly where the vehicle speed is 0 kph, or where the vehicle is located in an area, such as a maintenance area (e.g. a pit lane or garage) where vehicle maintenance is to be undertaken such as brake bleeding. As such it can be preferable to maintain the valve 1010 in an open position to permit brake bleeding.

After the determination step S4020 the flow chart 4000 moves to step S4030. Step S4030 is a decision step with two branches a ‘Y’ branch which moves the control system logic to step S4040 if the control system 1200 has determined that the lateral acceleration event has begun or is likely to begin shortly, and a ‘N’ branch which moves the control system logic to step S4050 where the lateral acceleration event is not determined to have begun or deemed likely to be beginning.

At step 4050 the flow chart terminates.

At step S4040 the control system 1202 outputs the one or more output signals 1302 including the valve signal 1320. The valve signal 1320 requests that the electromechanical valve 1010 is to be closed. After the control system 1202 outputs the output signal 1302 the logic terminates.

The logic of the second control system 1202 may be combined with the logic of the first control system 1200 such that the second control system 1202 (or first control system 1200) may undertake the methods of flow charts 2000, 3000 and/or 4000 simultaneously or optionally.

As will be apparent to the skilled reader, various modifications and/or changes may be made to the present invention without departing from the scope of the present disclosure.

The following numbered clauses include embodiments that are contemplated and non-limiting:
1. A control system for controlling a brake system of a vehicle, the brake system comprising a brake fluid reservoir fluidically connected to a hydraulically actuated brake via an electromechanical valve, the control system comprising one or more processors collectively configured to:
   determine or receive an acceleration signal comprising information indicative of a vehicle lateral acceleration;
   determine whether the vehicle lateral acceleration is at or exceeds a predetermined threshold value; and
   output a valve signal for actuating the electromechanical valve dependent on whether the vehicle lateral acceleration is at or exceeds the predetermined threshold value.
2. A control system according to clause 1, wherein the valve signal is configured to open the electromechanical valve when the vehicle lateral acceleration is below the predetermined threshold value, and wherein the valve signal is configured to close the electromechanical valve when the vehicle acceleration is at or exceeds the predetermined threshold value.
3. A control system according to clause 2, wherein the one or more processors are further collectively configured to:
   determine or receive a valve position signal comprising information indicative of the position of the electromechanical valve;
   determine, based on a determination that the vehicle lateral acceleration does not exceed the predetermined threshold value, whether the electromechanical valve is in an open or closed position; and
   output a delay signal for delaying opening of the electromechanical valve if the valve is in the closed position.
4. A control system according to clause 3, wherein the delay signal is configured to delay actuation of the electromechanical valve by at least 0.5 seconds to 10 seconds, preferably by at least 2 seconds, further preferably by at least 1 second.
5. A control system according to any preceding clause, wherein the one or more processors are further collectively configured to:
   determine or receive a vehicle parameter signal comprising information indicative of one or more of: a brake request, steering angle, vehicle roll angle, GPS data, vehicle speed, and suspension height;
   determine, based on the information contained within the vehicle parameter signal, whether a lateral acceleration event has begun or whether a lateral acceleration event is likely to begin;
   output the valve signal based on a determination that a lateral acceleration event has begun; or
   output the valve signal based on a determination that a lateral acceleration event is likely to begin; or
   output, based on a determination that a lateral acceleration event has not begun, an override signal for opening the electromechanical valve; and/or
   do not output the valve signal based on a determination that a lateral acceleration event has not begun.
6. A brake system comprising the control system according to any preceding clause and a brake circuit, the brake fluid circuit comprising: a brake fluid reservoir, a hydraulically actuated brake and an electromechanical valve;
   wherein the electromechanical valve is located between the brake fluid reservoir and the hydraulically actuated brake;
   the electromechanical valve being actuatable between an open position configured to fluidly connect the brake fluid reservoir and the hydraulically actuated brake, and a closed position to fluidly disconnect the brake fluid reservoir and the hydraulically actuated brake.
7. A brake system of clause 6, wherein the electromechanical valve is biased towards the open position.
8. A brake system according to clause 6 or 7, wherein the brake system further comprises a volume compliance chamber fluidically connected to the hydraulically actuated brake and configured to maintain fluid pressure and/or brake fluid volume within the brake system.
9. A brake system according to clause 8, wherein the volume compliance chamber has a first configuration with a first volume and a second configuration with a second volume, the first volume being greater than the second volume.
10. A brake system according to clause 8 or 9, wherein the volume compliance chamber is biased to the second configuration.
11. A vehicle comprising the brake system of any of clauses 6 to 11 or the control system of any of clauses 1 to 5.
12. A method of controlling a brake system comprising a brake fluid reservoir fluidically connected to a hydraulically actuated brake via an electromechanical valve, the method comprising the steps of:
   determining or receiving an acceleration signal comprising information indicative of a vehicle lateral acceleration;
   determining whether the vehicle lateral acceleration is at or exceeds a predetermined threshold value; and
   outputting a valve signal for actuating the electromechanical valve dependent on whether the vehicle lateral acceleration exceeds the predetermined threshold value.
13. A method of controlling a brake system according to clause 12, wherein the valve signal is configured to open the electromechanical valve when the vehicle acceleration is below the predetermined threshold value, and wherein the valve signal is configured to close the electromechanical valve when the vehicle acceleration is at or exceeds the predetermined threshold value.
14. A method of controlling a brake system according to clause 12 or 13, further comprising the steps of:
   determining, based on the information contained within the vehicle parameter signal, whether a lateral acceleration event has begun or whether a lateral acceleration event is likely to begin;
   outputting the valve signal based on a determination that a lateral acceleration event has begun; or
   outputting the valve signal based on a determination that a lateral acceleration event is likely to begin; or
   outputting, based on a determination that a lateral acceleration event has not begun, an override signal for opening the electromechanical valve; and/or not outputting the valve signal based on a determination that a lateral acceleration event has not begun.
15. A control system for controlling a brake system of a vehicle, the brake system comprising a brake fluid reservoir fluidically connected to a hydraulically actuated brake via an electromechanical valve, the control system comprising one or more processors collectively configured to:
   determine or receive a vehicle parameter signal comprising information indicative of one or more of: a brake request, steering angle, vehicle roll angle, GPS data, vehicle speed, vehicle lateral acceleration and suspension height;
   determine, based on the information contained within the vehicle parameter signal, whether a lateral acceleration event has begun or whether a lateral acceleration event is likely to begin;
   output a valve signal for actuating the electromechanical valve based on a determination that a lateral acceleration event has begun or is likely to begin.
16. A fluid transit prevention device for a hydraulically actuated brake comprising:
   a body defining a fluid channel having an inlet and an outlet spaced apart from one another;
   a first inertia mass;
   a second inertia mass;
   a fluid channel closure arranged between the inlet and outlet, which is actuable between an open condition in which fluid can flow in the fluid channel between the inlet and outlet and vice versa and a closed condition in which fluid is prevented from flowing in the fluid channel between the inlet and outlet and vice versa;
   a first biasing means arranged to act on the first inertia mass in a first direction away from the fluid channel closure; and
   a second biasing means arranged to act on the second inertia mass in a second direction opposite from the first direction and away from the fluid channel closure;
wherein each inertia mass is arranged, under appropriate acceleration, to actuate the fluid channel closure from the open condition to the closed condition and wherein the fluid channel closure is configured to return to the open condition when not acted upon by either of the first or second inertia masses.
17. The fluid transit prevent device according to clause 16, wherein the fluid channel closure comprises a first reciprocating means and a second reciprocating means.
18. The fluid transit prevent device according to clause 17, wherein the first and second reciprocating means are first and second valves respectively.
19. The fluid transit prevent device according to any of clauses 16 to 18, wherein at least one of the inertia masses is formed as part of the fluid channel closure.
20. The fluid transit prevent device according to any of clauses 16 to 19, wherein at least one of the biasing means comprises an incline plane arranged to encourage one of the inertia masses away from the respective reciprocating means.
21. The fluid transit prevent device according to any of clauses 16 to 19, wherein at least one of the biasing means is a spring.
22. The fluid transit prevent device according to any of clauses 16 to 19, wherein at least one of the biasing means is an electromagnet.
23. The fluid transit prevention device according to clause 20, further comprising:
   a first chamber having an inlet and the first valve, the first valve having a first valve member and a first biasing member, said first biasing member arranged to move said first valve member into the first chamber and thus from the closed position to the open position; and
   a second chamber having an outlet and the second valve, the second valve having a second valve member and a second biasing member, said second biasing member arranged to move said second valve member into the second chamber and thus from the closed position to the open position;
wherein the first inertia mass is arranged within the first chamber and arranged to move within said chamber along a first axis upon acceleration of the device in a first direction, said movement causing the first inertia mass to act on the first valve member against the first biasing member, moving the first valve member from the open position to the closed position; and
wherein the second inertia mass is arranged within the second chamber and arranged to move within said chamber along a second axis upon acceleration of the device in a second direction, said movement causing the second inertia mass to act on the second valve member against the second biasing member, moving the second valve member from the open position to the closed position;
wherein the first and second valves are fluidly connected and the first and second chambers are relatively inclined such that the first and second axes are non-parallel.
24. The fluid transit prevention device according to clause 23, further comprising a horizontal axis and wherein at least one of the first and second axes is inclined relative to said horizontal axis.
25. The fluid transit prevention device according to clause 24, wherein the first and second axes are inclined relative to the horizontal axis.
26. The fluid transit prevention device according to any of clauses 23 to 25, wherein the first and second chambers are formed within a single body.
27. The fluid transit prevention device according to any of clauses 23 to 26, wherein at least one of the first and second inertia masses is spherical.
28. The fluid transit prevention device according to any of clauses 23 to 27, wherein the first and second inertia masses are spherical.
29. The fluid transit prevention device according to clause 28, wherein the first and second inertia masses are steel balls, preferably stainless steel.
30. The fluid transit prevention device according to either of clauses 28 or 29, wherein the first and second chambers are substantially cylindrical.
31. The fluid transit prevention device according to clause 30, wherein the first and second inertia masses have diameters proximate to that of the diameter of the respective first or second chamber, such that minimal fluid can pass between the inertia mass and walls of the respective chamber.
32. The fluid transit prevention device according to any of clauses 23 to 31, wherein at least one of the first and second biasing members is a spring.
33. The fluid transit prevention device according to any of clauses 23 to 32, wherein the first and second biasing members are springs.
34. The fluid transit prevention device according to either of clauses 32 or 33, wherein each spring is a conical spring having a narrow end and a wide end.
35. The fluid transit prevention device according to clause 34, wherein each spring is arranged such that the narrow end acts on the respective chamber and the wide end acts on the respective valve member.
36. The fluid transit prevention device according to any of clauses 23 to 35, the first and second valves further comprising a first and second pin respectively, each attached to the first and second chamber respectively, and
   the first and second valve members having first and second bores respectively therethrough,
   wherein the first and second pins are arranged to pass through the first and second bores respectively to secure the first and second valve members to the first and second chamber respectively, whilst still allowing movement between the respective valve member and chamber.
37. The fluid transit prevention device according to clause 36, wherein the first and second valve members have a shaft portion and a head portion.
38. The fluid transit prevention device according to clause 37, wherein each shaft portion has at least one hole therethrough to allow the passage of fluid.
39. The fluid transit prevention device according to clause 38, wherein the holes are arranged such that they are blocked by the respective chamber when the valve member is in the closed position.
40. The fluid transit prevention device according to any of clauses 36 to 39, wherein the first and second bores are shaped to receive the respective inertia mass.
41. A fluid brake system comprising:
   a brake caliper assembly having at least one piston with a master cylinder;
   the fluid transit prevention device according to any of the preceding clauses; and
   a fluid reservoir;
wherein the fluid reservoir is fluidly connected to the inlet of the fluid transit prevention device and the master cylinder is fluidly connected to the outlet of the fluid transit prevention device.
42. The fluid brake system according to clause 41, wherein the master cylinder is fluidly connected to the outlet of the fluid transit prevention device via a collapsible hose.
43. The fluid brake system according to clause 42, wherein an internal cross-sectional area of the collapsible hose is arranged to reduce when the fluid channel closure of the fluid transit prevention device is in the closed condition.
44. A fluid brake system comprising:
   a brake caliper assembly having at least one piston with a master cylinder;
   a valve having an inlet and an outlet; and
   a fluid reservoir;
wherein the fluid reservoir is fluidly connected to the inlet of the valve and the master cylinder is fluidly connected to the outlet of the valve, and the valve is arranged to move between a closed position and an open position as a reaction to lateral acceleration of the fluid brake system.
45. The fluid brake system according to clause 44, wherein the valve is the fluid transit prevention device according to any of clauses 16 to 40.
46. The fluid brake system according to either of clauses 44 or 45, wherein the master cylinder is fluidly connected to the outlet of the valve via a collapsible hose.
47. The fluid brake system according to clause 46, wherein an internal cross-sectional area of the collapsible hose is arranged to reduce when the valve is in the closed condition.
48. A method of operating a fluid transit prevention device for a hydraulically actuated brake, the fluid transit prevention device comprising a body defining a fluid channel having an inlet and an outlet spaced apart from one another; a first inertia mass; a second inertia mass; a fluid channel closure arranged between the inlet and outlet, which is actuable between an open condition in which fluid can flow in the fluid channel between the inlet and outlet and vice versa and a closed condition in which fluid is prevented from flowing in the fluid channel between the inlet and outlet and vice versa; a first biasing means arranged to act on the first inertia mass in a first direction away from the fluid channel closure; and a second biasing means arranged to act on the second inertia mass in a second direction opposite from the first direction and away from the fluid channel closure; the method comprising the steps of:
   a) subjecting the fluid prevention device to an acceleration with a component parallel to the either of the first or second directions;
   b) upon reaching an appropriate acceleration in the direction of the component, one of the first and second inertia masses acting on the fluid channel closure;
   c) the fluid channel closure moving from the open condition to the closed condition;
   d) upon a reduction in acceleration below the appropriate acceleration, the first or second inertia mass ceasing to act on the fluid channel; and
   e) the fluid channel closure returning to the open condition.

1. A control system for controlling a brake system of a vehicle, the brake system comprising a brake fluid reservoir fluidically connected to a hydraulically actuated brake via an electromechanical valve, the control system comprising one or more processors collectively configured to:
determine or receive an acceleration signal comprising information indicative of a vehicle lateral acceleration;
determine whether the vehicle lateral acceleration is at or exceeds a predetermined threshold value; and
output a valve signal for actuating the electromechanical valve dependent on whether the vehicle lateral acceleration is at or exceeds the predetermined threshold value.

2. A control system according to claim 1, wherein the valve signal is configured to open the electromechanical valve when the vehicle lateral acceleration is below the predetermined threshold value, and wherein the valve signal is configured to close the electromechanical valve when the vehicle acceleration is at or exceeds the predetermined threshold value.

3. A control system according to claim 2, wherein the one or more processors are further collectively configured to:
determine or receive a valve position signal comprising information indicative of the position of the electromechanical valve;
determine, based on a determination that the vehicle lateral acceleration does not exceed the predetermined threshold value, whether the electromechanical valve is in an open or closed position; and
output a delay signal for delaying opening of the electromechanical valve if the valve is in the closed position.

4. A control system according to claim 3, wherein the delay signal is configured to delay actuation of the electromechanical valve by at least 0.5 seconds to 10 seconds, preferably by at least 2 seconds, further preferably by at least 1 second.

5. A control system according to claim 1, wherein the one or more processors are further collectively configured to:
determine or receive a vehicle parameter signal comprising information indicative of one or more of: a brake request, steering angle, vehicle roll angle, GPS data, vehicle speed, and suspension height;
determine, based on the information contained within the vehicle parameter signal, whether a lateral acceleration event has begun or whether a lateral acceleration event is likely to begin;
output the valve signal based on a determination that a lateral acceleration event has begun; or
output the valve signal based on a determination that a lateral acceleration event is likely to begin; or
output, based on a determination that a lateral acceleration event has not begun, an override signal for opening the electromechanical valve; and/or
do not output the valve signal based on a determination that a lateral acceleration event has not begun.

6. A brake system comprising the control system according to claim 1 and a brake circuit, the brake fluid circuit comprising: a brake fluid reservoir, a hydraulically actuated brake and an electromechanical valve;
wherein the electromechanical valve is located between the brake fluid reservoir and the hydraulically actuated brake;
the electromechanical valve being actuatable between an open position configured to fluidly connect the brake fluid reservoir and the hydraulically actuated brake, and a closed position to fluidly disconnect the brake fluid reservoir and the hydraulically actuated brake.

7. A brake system of claim 6, wherein the electromechanical valve is biased towards the open position.

8. A brake system according to claim 6, wherein the brake system further comprises a volume compliance chamber fluidically connected to the hydraulically actuated brake and configured to maintain fluid pressure and/or brake fluid volume within the brake system.

9. A brake system according to claim 8, wherein the volume compliance chamber has a first configuration with a first volume and a second configuration with a second volume, the first volume being greater than the second volume.

10. A brake system according to claim 8, wherein the volume compliance chamber is biased to the second configuration.

11. A vehicle comprising the brake system of claim 6 or the control system of claim 1.

12. A method of controlling a brake system comprising a brake fluid reservoir fluidically connected to a hydraulically actuated brake via an electromechanical valve, the method comprising the steps of:
determining or receiving an acceleration signal comprising information indicative of a vehicle lateral acceleration;
determining whether the vehicle lateral acceleration is at or exceeds a predetermined threshold value; and
outputting a valve signal for actuating the electromechanical valve dependent on whether the vehicle lateral acceleration exceeds the predetermined threshold value.

13. A method of controlling a brake system according to claim 12, wherein the valve signal is configured to open the electromechanical valve when the vehicle acceleration is below the predetermined threshold value, and wherein the valve signal is configured to close the electromechanical valve when the vehicle acceleration is at or exceeds the predetermined threshold value.

14. A method of controlling a brake system according to claim 12, further comprising the steps of:
determining, based on the information contained within the vehicle parameter signal, whether a lateral acceleration event has begun or whether a lateral acceleration event is likely to begin;
outputting the valve signal based on a determination that a lateral acceleration event has begun; or
outputting the valve signal based on a determination that a lateral acceleration event is likely to begin; or
outputting, based on a determination that a lateral acceleration event has not begun, an override signal for opening the electromechanical valve; and/or
not outputting the valve signal based on a determination that a lateral acceleration event has not begun.

15. A control system for controlling a brake system of a vehicle, the brake system comprising a brake fluid reservoir fluidically connected to a hydraulically actuated brake via an electromechanical valve, the control system comprising one or more processors collectively configured to:
determine or receive a vehicle parameter signal comprising information indicative of one or more of: a brake request, steering angle, vehicle roll angle, GPS data, vehicle speed, vehicle lateral acceleration and suspension height;
determine, based on the information contained within the vehicle parameter signal, whether a lateral acceleration event has begun or whether a lateral acceleration event is likely to begin;
output a valve signal for actuating the electromechanical valve based on a determination that a lateral acceleration event has begun or is likely to begin.

16-48. (canceled)
